(19) United States
(12) Patent Application Publication
(10) Pub. No.: US 2026/0057288 A1
(43) Pub. Date: Feb. 26, 2026

(54) SYSTEM AND METHOD FOR INTEGRATING AI ASSISTANT INTO ANY SERVICE

(71) Applicant: Salesforce, Inc., San Francisco, CA (US)

(72) Inventors: Avigad Mizrahi, Tel Aviv (IL); Ofer Bachner, Tel Aviv (IL)

(21) Appl. No.: 18/811,645

(22) Filed: Aug. 21, 2024

(51) Int. Cl. G06N 20/00

(52) U.S. Cl. CPC G06N 20/00

(57) ABSTRACT

Techniques for generating a customized artificial intelligence (AI) assistant that can be integrated into existing systems or services are discussed herein. In some examples, an AI assistant management system may receive access to source code data (e.g., a source code repository) associated with a client application or system. The AI assistant management system may generate a training data based in part on analyzing the source code data. The AI assistant management system may train and/or fine-tune a large language model (LLM) based on the training data such that the customized LLM is equipped with the capability to respond to user queries regarding the particular client application. The customed LLM may be associated with a generated AI assistant component. The AI assistant management system may send the AI assistant component to the client for integration into the client application.

### BACKGROUND

The use of artificial intelligence (AI) is increasingly becoming more popular due to its ability to enhance productivity and user experience. However, generating, training, and retraining machine learning models is a cumbersome, error prone process, and requires specialized knowledge of machine learning techniques.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates an example system for performing techniques described herein.

FIG. 2 illustrates another example system for receiving access to source code data, analyzing the source code data, generating and training a machine learning model, generating an AI assistant component, and sending the AI assistant component to a client system for integration according to examples of the present disclosure.

FIG. 3 illustrates an example environment for generating an executable plan defining a series of steps to be performed.

FIG. 4 is a flow diagram illustrating an example process for receiving an indication that the source code has been altered, receiving access to the altered source code, generating additional training data, and retraining the machine learning model based on the additional training data.

### DETAILED DESCRIPTION

Modern software development has evolved towards web applications and cloud-based applications that provide access to data and services via the Internet or other networks. Businesses also increasingly interface with customers using different electronic communications channels, including online chats, text messaging, email, or other forms of remote support. Artificial intelligence (AI) may also be used to provide information to users via online communications with AI assistants, chatbots, or other automated interactive tools. Users can interact with the AI assistant and make requests for information. However, an AI assistant or other AI system generally provides information to users for predetermined situations and applications, and in practice, may be limited depending on the nature of the training data utilized to develop the AI assistant.

AI assistants often use large language models (LLMs) that have access to or knowledge of a larger data set and vocabulary, such that they are more likely to have applicable information for a wide range of potential input prompts. That said, there may still be scenarios where the AI assistant does not have access to all applicable information or is otherwise unable to provide a satisfactory answer. For example, LLMs may lack context or other understanding of information or situations that are not represented within their training data, which can impair the ability of LLMs to provide accurate or contextually relevant responses. Accordingly, it is desirable to provide systems and methods that facilitate more accurate and contextually relevant output responses from an AI assistant to a particular input prompt that might otherwise be outside the scope of the training data.

As described above, conventional techniques for developing an AI assistant are a cumbersome process and requires the gathering of large amounts of data. Currently, when a business or other entity decides to incorporate an AI assistant into an existing application or system, the business must first determine the information desired by clients or customers, and then devise rule-based logic to match each user request with the appropriate piece of code. This method is laborious, expensive, and time-consuming, requiring manual work to identify which information is required by clients. This can be a difficult to achieve, if not impossible. Moreover, this process can be error prone, resulting in limited functionality for clients. Additionally, a conventional AI assistant may be restricted in the information it provides if the AI assistant has not been pre-configured to understand nuances of relevant code associated with a particular client application.

Techniques for generating a customized AI assistant (or chatbot) that can be integrated into existing systems or services are discussed herein. An AI assistant management system is configured to learn the intricacies of each client's business and functions and equips the AI assistant with the capability to respond to questions (or user queries) within the scope of the service's functionality (e.g., accessible through APIs). That is, the AI assistant management system is configured to analyze the intricacies of a client's source code data as well as the spectrum of available services and APIs to train and/or fine tune a large language model (LLM) unique to that particular client application or system. Based on the analysis of the source code data and API data, the AI assistant management system can generate an AI assistant component that can be integrated quickly and easily into a client's existing application. That is, the AI assistant component can quickly be embedded into the user interface (UI) of the client application by the client.

Upon receiving a user query, the customized LLM associated with the AI assistant may be configured to formulate an executable plan to deliver responses. As used herein, an executable plan is a structured strategy or series of steps designed to achieve a goal or carry out a particular task. An executable plan may outline a list of steps that are to be performed and in what order. The LLM facilitates natural language interactions with end users and serves as the conduit between users and the AI assistant management system, transmitting user input and receiving executable plans in return.

The AI assistant management system employs continuous learning techniques so that the AI assistant management system can update customized LLMs (and corresponding AI assistants) with new functionalities that are released by the client. In some instances, the AI assistant management system may send an automated request to a client system for an updated (or new) source code repository and/or new API documentation data at predetermined intervals.

The techniques described herein can improve the functioning, efficiency, and overall user experience associated with generating and using AI assistants. For example, the AI assistant management system facilities effortless integration of a generated AI assistant into a client system, bypassing the need for manual coding and modernizing the conventional labor-intensive process. The AI assistant management system uses machine learning (ML) models, such as large language models, and code analysis techniques to comprehensively grasp the nuances of a client's business. The AI assistant management system identifies existing functionalities within the source code so that responses to user inquiries generated by the customized LLM are more relevant and precise to users of the client application, removing the traditional constraints associated with pre-configured responses or coded implementation. The AI assistant component can address user queries that may be unique to a client's business, improving the user experience. The AI assistant management system can autonomously acquire insights into individual client's business nuances and operations, eliminating the cumbersome manual process of identifying information by customers, which is laborious and often error prone. The AI assistant management system employes continuous learning techniques to dynamically adapt to changes in the source code. This ensures that new features and functionalities introduced by the client are promptly captured and made available to the AI assistant, enabling the AI assistant to stay up to date with the latest developments in the client service without manual intervention or monitoring.

Conventional AI assistant integration methods often require the installation of new services or the allocation of additional computational resources. In contrast, the AI assistant management system provides clients with a resource bundle (e.g., a bundle of files grouped together for a particular purpose) that can easily be loaded from the internet. The resource bundle contains the components to run the AI assistant seamlessly within the client's front-end environment (e.g., parts of the client's environment that interact with users, such as the UI). This reduces deployment complexities for the client and associated costs with integrated a new service as well as decreases the use of the client's computing resources. The customized LLM fine-tuned by the AI assistant management system is capable of identifying relevant API calls even in the absence of explicit specifications in the source code or API documentation, allowing the AI assistant to improve the extraction of desired data from API responses.

The techniques described herein can improve the functioning, efficiency, and overall experience for the involved users and systems (e.g., client systems and AI assistant management system). That is, the techniques described herein may reduce potential latency issues of at least client computing devices and systems. For example, the AI management system can generate and execute at least a portion of the executable plan on behalf of the client system. Further, the techniques may reduce storage/memory requirements for client systems as the AI assistant management system manages the generation and fine-tuning of the LLM on behalf of the clients as the process of generating and fine-tuning LLMs can necessitate specialized hardware (e.g., graphics processing units, tensor processing units, etc.) and can involve significant computational power, resources, memory, data storage, etc.

The following detailed description of examples references the accompanying drawings that illustrate specific examples in which the techniques can be practiced. The examples are intended to describe aspects of the systems and methods in sufficient detail to enable those skilled in the art to practice the techniques discussed herein. Other examples can be utilized, and changes can be made without departing from the scope of the disclosure. The following detailed description is, therefore, not to be taken in a limiting sense. The scope of the disclosure is defined only by the appended claims, along with the full scope of equivalents to which such claims are entitled.

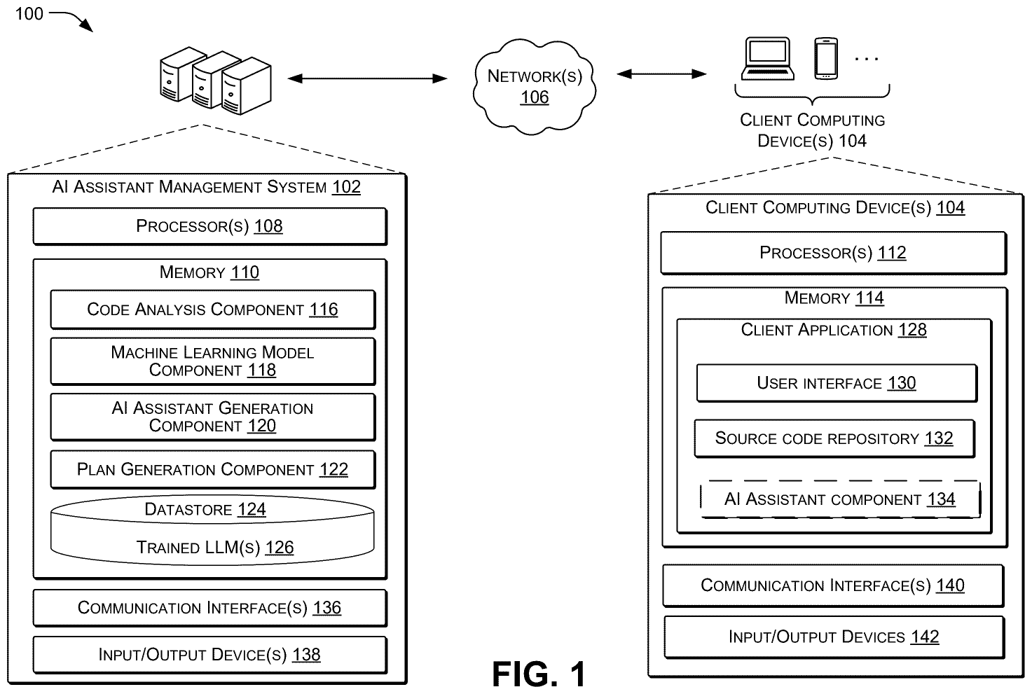

FIG. 1 illustrates an example environment 100 for performing the techniques described herein. The techniques discussed herein may be used in a variety of environments and for a variety of uses, although the examples given herein discuss a client (or customer) service environment as one of these use cases since it's a use case familiar to many. In additional or alternate examples, the computing environment may comprise computing devices used for sales-based systems, communication platforms, chat engines, cybersecurity, search engines, multi-agent/agentic machine-learned model pipeline(s) and/or cluster(s), machine-learned model training, cloud/distributed computing or massive computing efficient data storage and/or retrieval, and/or the like.

In at least one example, the example environment 100 can include an AI assistant management system 102 and/or a client computing device(s) 104. By way of example and not limitation, the AI assistant management system 102 may be associated with servers for hosting software, hardware, containers, and/or the like to implement at least the techniques discussed herein. For example, the AI assistant management system 102 may be associated with a server(s) that host (e.g., store and/or execute) system software. The client computing device(s) 104 may be representative of client computing device(s) associated with a first user (i.e., a first “client device”).

The server(s) associated with the AI assistant management system 102 may comprise one or more individual servers or other computing devices that may be physically located in a single central location or may be distributed at multiple different locations. The AI assistant management system may include server(s) that may be hosted privately by an entity administering all or part of the environment 100 (e.g., a utility company, a governmental body, distributor, a retailer, manufacturer, etc.), or may be hosted in a cloud environment, or a combination of privately hosted and cloud hosted services. In some examples, the functional components and/or data discussed herein can be implemented on a single server, a cluster of servers, a server farm or data center, a cloud-hosted computing service, a cloud-hosted storage service, and so forth, although other computer architectures can additionally or alternatively be used. Moreover, the AI assistant management system 102 may comprise hardware and/or software containers accessible to different tenants with access to the server(s) associated with the AI assistant management system 102.

The client computing device(s) 104 may be any suitable type of computing device, e.g., portable, semi-portable, semi-stationary, or stationary. Some examples of the client computing device(s) 104 can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. In some examples, the client computing device(s) 104 may comprise distributed computing devices, server(s), etc. The client computing device(s) 104 may be associated with any type of customer or client service environment (e.g., telecommunication or cell solution).

In some examples, the AI assistant management system 102 and/or client computing device(s) 104 may be configured to transmit network packages therebetween via network(s) 106. The network(s) 106 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, cellular network, or any other such network, or any combination thereof. The network(s) 106 may comprise a single network or collection of networks, such as the Internet, a corporate intranet, a virtual private network (VPN), a local area network (LAN), personal area network (PAN), metropolitan area network (MAN), a wireless local area network (WLAN), a cellular network, a wide area network (WAN), a metropolitan area network (MAN), or a combination of two or more such networks, over which the client computing device(s) 104 may transmit a request to and/receive an output from the AI assistant management system 102. Components used for such communications can depend at least in part upon the type of network, the environment selected, or both. Further, the network(s) 106 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the AI assistant management system 102. In some embodiments, the protocol is a custom protocol of JSON objects sent via a Websocket channel. In some embodiments, the protocol is JSON over RPC, JSON over REST/HTTP, and the like.

The AI assistant management system 102 and the client computing device(s) 104 described herein may include one or more processors and/or memory. Specifically, in the illustrated example, AI assistant management system 102 may include processor(s) 108 and memory 110 and client computing device(s) 104 include processor(s) 112 and memory 114.

By way of example and not limitation, the processor(s) 108 and/or 112 may comprise one or more central processing units (CPUs), graphics processing units (GPUs), tensor processing units (TPUs), field-programmable gate arrays (FPGAs), and/or process-acceleration devices such as application-specific integrated circuits (ASICs) or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions. For example, the processor(s) 108 and/or 112 can be one or more hardware processors and/or logic circuits of any suitable type specifically programmed or configured to execute the algorithms and processes described herein. The processor(s) 108 and/or 112 can be configured to fetch and execute computer-readable instructions stored in the computer-readable media, which can program the processor(s) to perform the functions described herein.

The memory 110 and/or 114 may comprise one or more non-transitory computer-readable media and may store software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/flash-type memory, RAM, ROM, EEPROM, flash memory, optical storage, solid state storage, magnetic tape, magnetic disk storage, RAID storage systems, storage arrays, network attached storage, storage area networks, cloud storage, or any other medium for storing information. The architectures, systems, and individual elements described herein may include many other logical, programmatic, and physical components, of which those shown in the accompanying figures are merely examples that are related to the discussion herein. The memory 110 and/or 114 can be used to store any number of software/functional components that are executable by the processor(s) 108 and/or 112, respectively. In many implementations, these functional components comprise instructions or programs that are executable by the processor(s) 108 and/or 112 and that, when executed, specifically configure the processor(s) 108 and/or 112 to perform actions for the AI assistant management system 102 and/or client computing device(s) 104, according to the discussion herein.

The AI assistant management system 102 may comprise a memory 110 storing one or more of a code analysis component 116, machine learning model component 118, AI assistant generation component 120, and/or a plan generation component 122.

In some examples, the code analysis component 116 may analyze source code data (or simply “source data” or “code data”). In some examples, the code analysis component 116 may transform (or translate) the source code data into machine code using a compiler, assembler, and/or other computer program that translates computer code written in programming language (i.e., source language) into a target language (i.e., machine code). The resulting executable data is machine code ready to be analyzed by a computing device. In some examples, the code analysis component can analyze the source code without conversion using an interpreter by loading the source code into a memory. In some examples, the code analysis component 116 may convert the source code into bytecode or other intermediate representation of source code that can be interpreted and analyzed.

The code analysis component 116 can analyze source code and identify a client application's business logic as well as other existing functionalities and implementation within the source code and client application. This data can be utilized to fine-tune a customized large language model (LLM) that can perform tasks unique to a client application. That is, an LLM can be trained to understand particular business use cases associated with a client's business and/or client application. A business use case can be a scenario or sequence of events that iterates how a user (e.g., a customer, employee, another system, etc.) interacts with a client's application to achieve a particular goal. A business use case can include information related to a user that interacts with a system or application, a particular objective the user wants to achieve, data related to events that achieve the desired goal, data related to events that trigger a use case (e.g., trigger events), and the like. For example, in the case of an online retail application, a business use scenario may include receiving customer details when a user creates a user account, data related to how a customer purchases a product (e.g., how a customer searches for a product, adds items to a cart, enters payment information, completes purchases, etc.), data related to how a customer returns a product, data related to how a customer subscribes to a newsletter (e.g., providing an email address), etc. To provide another non-limiting example, in the case of a banking application, business use scenarios may include information related to how a customer opens a bank account, applies for a loan, transfers money, etc. As another non-limiting example, in the case of an insurance application, business user scenarios may include data related to a customer filing an insurance claim, data related to an insurance agent evaluating a claim (e.g., assessing damages), policy renewal data, etc. As noted above, data related to how a user interacts with the client's application can be utilized to generate training data that can then be used to train a customized LLM. The customized LLM can then be used in association with an AI assistant component (e.g., a chat bot) that understands the intricacies of a client's business, possessing familiarity with both the source code and the entire spectrum of available services and APIs.

The source code data may be received from one or more client computing device(s) 104. Source code data may include a plain text listing of commands that are compiled into an executable computer program (e.g., software including an operating system(s), application software, etc.). Source code may represent an original code written by developers of a client application and defines a functionality and behavior of a client application or service. That is, the source code data can be programming code or instructions and logic utilized by the client application. For example, the source code data can include algorithms, data structure, configuration data (e.g., a configuration file that defines database connection parameters), domain logic data, data access, presentation logic (e.g., user interface code), APIs, controllers, data repositories (e.g., a data repository for accessing user data from a database), etc., that enable the client application to perform its intended tasks. Source code data can be compiled or interpreted to run on server(s), providing a desired functionality to end users or other services.

The code analysis component 116 may be configured to analyze source code. For example, the code analysis component 116 may analyze source code using one or more static code analysis techniques. Static code analysis techniques analyze the source code without executing it. In some examples, the code analysis component 116 can scan the source code for potential errors, performance or other quality attributes, security vulnerabilities within the source code, and/or adherence to code standards. In some examples, code analysis component 116 may analyze the source code and detect the presence of potential runtime errors, dead code (e.g., code that is never executed), repeated code (or cloned code), software bugs or issues, syntax errors (e.g., mistakes in code that prevent it from running correctly), performance issues (e.g., code that is inefficient and may leads to performance bottlenecks), etc. In some examples, any potential code errors or vulnerabilities detected during code analysis may be reported to the client (e.g., an automated message, email, etc. may be sent to the client device).

In some examples, the code analysis component 116 analyzes the source code data in order to identify and understand the domain logic (or business logic). Domain logic represents software that encodes real-world business rules that determine how data associated with an application is generated, stored, updated, changed, etc. Domain logic can encompass the algorithms, processes, and rules that are specific to an application's domain. In some examples, the domain logic can reflect the particular business rules, policies, and/or procedures of the domain particular to the client application. In some examples, the domain logic may be encapsulated within classes (e.g., a blueprint for creating objects in object-oriented programming (OOP)) within the source code such that the business rules and operations are organized within a data structure. For example, the code analysis component 116 may analyze the source code of an e-commerce type application and identify one or more classes, such as a product class (e.g., a class representing a product in an e-commerce type application with attributes like ‘name’ and ‘price), order item class (e.g., representing an item in an order and including a reference to the ‘product’ and the ‘quantity’ ordered), order class (e.g., representing the order itself and containing multiple ‘order item’ objects). The order class may encapsulate logic related to adding a new item to an order, calculating the total cost of all items in an order and applying any discounts, logic related to marking the order as complete, checking for errors like empty orders or already processed orders, logic related to handing payment processing, canceling orders, and the like.

To provide a non-limiting example, in the case of a banking application, domain logic can include operational data related to how interest is calculated, how a transaction is processed, how an account number is validated, and the like. Domain logic can be implemented as part of a client application's source code. In some examples, domain logic can include configuration files that contain settings or parameters that influence the behavior of the domain logic. For example, a financial accounting application may include a source code including a configuration file in JSON or YAML format that specifies discount rates or tax rules. To provide another example, an e-commerce application may include domain logic defining a process for adding items to a shopping cart (i.e., what set of rules to follow and in what order). To provide another example, an inventory management system may include domain logic related to stock control (e.g., how stock levels are tracked, how an alert is generated for low stock, how reorder points and quantities are managed), supplier management (e.g., purchase histories associated with various suppliers), warehouse operations (e.g., how packing routes are optimized for order fulfillment).

In some examples, the code analysis component 116 may analyze the source code using one or more machine learning (ML) models. For example, the code analysis component 116 may leverage large language model(s) to extract relevant information retrievable via APIs. A ML model may be trained (using supervising and/or unsupervised learning) to understand the source code, provide suggestions and/or corrections based on learned patterns from previous code reviews and/or a client's particular source code. For example, a ML model can predict missing lines or blocks of code based on understanding a context or function of the code that is present (e.g., using pattern recognition). The ML model can use various ML algorithms (e.g., decision trees, neural networks, support vector machines, etc.) to detect and learn patterns and make predictions as to the intent and purpose of the source code.

In some examples, the code analysis component 116 may analyze the source code data and API documentation data in order and identify one or more sets of rules that define existing functionalities within the service source code. For example, the code analysis component 116 may identify a first set of rules that define how data is created or generated within the client application. These rules may determine a structure, format, and/or content of data that is generated by the client application or system associated with the client application. For example, in the case of a client application that is configured to generate random IDs or passwords, the first set of rules may specify a length, character set (e.g., alphanumeric) and/or uniqueness requirements. In the case of a client application that is configured to timestamp data, the first set of rules may define the format and time zone for individual timestamps (e.g., generate a UTC timestamp in an international standard format).

In some examples, the code analysis component 116 may identify a second set of rules that define a method of storing data associated with the client application. That is, the second set of rules may define how data is stored in databases, files, or other storage systems associated with the client application (e.g., data associated with the client application is to be stored in a normalized form, sensitive data is to be encrypted and stored in a particular database, data is to be indexed in particular columns of a table, and the like).

In some examples, the code analysis component 116 may identify a third set of rules that define a method of modifying data associated with the client application. That is, the third set of rules may dictate how data is transformed or processed (or otherwise converted from one format to another) within the client application. For example, the third set of rules may define particular formats to data, such as formatting phone numbers or currency, data mapping values from one set to another (e.g., converting temperature from Celsius to Fahrenheit), and the like.

In some examples, the code analysis component 116 may identify a fourth set of rules that define how data is validated or verified by the client application. That is, the fourth set of rules may define how data associated with the client application meets certain criteria before it is accepted or processed. For example, the fourth set of rules may indicate that user inputs are to meet a particular format requirement, length, and/or type (e.g., validating an email address format), whether numerical inputs fall within a specified range (e.g., validating that a user's age is between 18 and 100), whether data like a username or ID is unique or already taken in the system, and the like.

In some examples, the code analysis component may identify additional sets of rules related to how the application accesses data (e.g., rules that define who can access or modify data within the client application or system), data integrity rules (e.g., rules that define how accuracy of data is maintained), and the like. These sets of rules are merely illustrative and more or different types of rule sets may be identified by the code analysis component 116.

A machine learning model component 118 is configured to generate, train, and/or fine-tune machine learning model(s) (e.g., large language models). The machine learning model component 118 may also generate training data sets based on source code data. For example, the machine learning model component 118 may generate a training data set based at least in part on using the source code data, domain logic (e.g., a set of rules, computations, processes related to the software application and define functionalities of the client application) and/or business logic (e.g., broader rules and workflows that dictate the behavior of an application based on a particular business's requirements) extracted from source code data or other data associated with a client application 128. Domain logic data can include data that encapsulates the core functionalities and rules that are particular to a client application's context.

For example, in the context of a banking application, domain logic can include rules related to operations such as calculating interest, processing transactions, and validating account numbers. To provide another non-limiting example, in the context of a healthcare application, platform, or system, a healthcare software application may include domain logic data related to patient record management, appointment scheduling, medical billing, and the like. Business logic data may be associated with high-level, broad processes or rules that govern operation of an application. Business logic data may encompass rules and workflows that align with a business's operational goals. For example, business logic data may indicate that orders from customers of group A are to be processed using discount B when exceeding amount C. As another non-limiting example, in the context of an e-commerce application, platform, or system, business logic data may include data related to order processing workflows, promotional discount calculations, inventory management, and the like.

In some examples, the machine learning model component 118 may train and tailor a particular LLM to a target service (e.g., a client application). The personalized LLM may be configured to respond to queries or user requests regarding the client application (or target service). The personalized LLM can be trained on data associated with existing functionalities within a client's source code and configured to generate precise responses to user inquiries.

An AI assistant generation component 120 generates an artificial intelligence (AI) assistant component. The AI assistant component may be associated with an AI assistant, chatbot, etc. that can receive user input. A generated AI assistant component may be provided to a client application for integration. That is, an AI assistant component may be integrated into a client application or platform so that it is part of a GUI. In some examples, the AI assistant component may provide the AI assistant component with a set of instructions that can be executed by the client application (e.g., a JavaScript™ script). The set of instructions may enable the AI assistant component to be integrated into a GUI of the client application. For example, the AI assistant component may be sent to the client computing device along with HyperText Markup Language (HTML) component tags and/or elements that are configured to display and/or accept data from a user of the client application. HTML component tags may include component tags or attributes that provide additional instructions associated with integrating the AI assistant component. For example, an ID attribute for a component tag can uniquely identify the AI assistant component. A rendered component tag attribute can specify whether or not the AI assistant component is to be rendered on the client GUI. A style component can specify a particular style of the AI assistant component.

The AI assistant component may be associated with instructions that define how the AI assistant (or chatbot) will be displayed, how data is to be collected from a user (e.g., via a text field or text area). The AI assistant UI component may be associated with instructions that define what message is displayed in association with the AI assistant. For example, a caption component may be associated with the AI assistant component and can instruct the user to “Give me a task to perform,” ask “what do you need help with?” or “What can I assist you with?” and the like. The AI assistant component may be associated with a text box that allows a user to interact with the AI assistant. For example, a user may input a request in the form of text or audio.

The AI assistant generation component may assign a unique identifier to the generated AI assistant component. The identifier may correspond to a target HTML element that enables the AI assistant management system 102 to toggle the AI assistant component on and off. This allows the AI assistant management system 102 to maintain control over the functionality of the AI assistant component. For example, the AI assistant management system 102 may allow clients to subscribe to an AI assistant service that provides personalized LLM chatbot or other AI assistant that generates a conversational response. At the end of the subscription period (e.g., if the client cancels the subscription), the AI assistant management system 102 can toggle the AI assistant component off automatically, ending the service.

Upon receiving a user query, a plan generation component 122 may generate an executable plan for performing the intended action. An executable plan is a structured strategy or series of steps designed to achieve a goal or carry out a particular task. An executable plan may outline a list of steps that are to be performed and in what order. For example, an executable plan may outline a plan of actions including API calls based on the trained LLM and the provided user input. The executable plan may be generated based in part on identifying or otherwise determining a current objective or intent of the user. A trained LLM may be configured to identify an intended action to be performed by the AI assistant component. For example, a user may request the AI assistant (or chatbot) perform a task such as “find my 10 most engaging friends,” “give me the specifications of this item,” “retrieve all the posts and comments for user profile X,” and the like. In response to the user request, the plan generation component may automatically generate an input prompt for an executable plan that corresponds to the intended action associated with the current user objective utilizing a trained LLM customized for the particular client application. The plan generation component 122 may generate an executable plan that includes steps to access various REST endpoints associated with the client application and combine the results to formulate an appropriate response. The plan generation component 122 may then return the executable plan to the AI assistant component associated with the client application for execution. That is, the AI assistant component may be configured to execute the plan and present results to the user. In some examples, the AI assistant management system executes at least a portion of the executable plan.

The memory 110 may additionally or alternatively comprise a portion of memory 110 (e.g., one or more memories or a portion of a single memory) that collectively forms a datastore 124 (e.g., a database). In some examples, the datastore 124 can be integrated with the AI assistant management system 102, as shown in FIG. 1. In other examples, the datastore 124 can be located remotely from the AI assistant management system 102 and can be accessible to the AI assistant management system 102 and/or computing device(s). The datastore 124 can comprise multiple databases, which can include trained large language models(s) (LLMs) 126. Additional or alternative data may be stored in the data store and/or one or more other data stores.

In at least one example, an operating system can manage the processor(s) 112, memory 114, hardware, software, etc. of the AI assistant management system 102.

In some examples, the AI assistant management system 102 may further comprise communication interface(s) 136, which can include one or more interfaces and hardware components for enabling communication with various other devices (e.g., the client computing device(s) 104), such as over the network(s) 106 or directly. In some examples, the communication interface(s) 136 can facilitate communication via WebSockets, APIs (e.g., using API calls), Hypertext Transfer Protocols (HTTPs), etc. The AI assistant management system 102 can further be equipped with various input/output devices 138 (e.g., I/O devices). Such input/output devices 138 can include a display, various user interface controls (e.g., buttons, joystick, keyboard, mouse, touch screen, etc.), audio speakers, connection ports, and so forth.

In at least one example, the client computing device(s) 104 can include processor(s) 112, memory 114, communication interface(s) 140, and/or input/output device(s) 142. The memory 110 may store and execute a client application 128, user interface 130, source code repository 132, and/or an AI assistant component 134. In some examples, the client application 128 may be configured to authenticate a user to access data and/or services hosted by the AI assistant management system 102.

The memory 114 may additionally or alternatively store application programming interface(s) (API(s)), hypervisor(s), container orchestration system(s), and/or an operating system. The API(s) may expose back-end functions and/or services hosted by the client computing device(s) 104. In some examples, software executed at the client computing device(s) 104, such as a client application 128, may generate and execute API call(s) and/or any of the component(s) discussed herein based on an executable plan generated by the plan generation component 122.

The client application 128 may be a software program that runs on a client device (e.g., computer, smartphone, tablet, etc.). A client application 128 may be a type of software that interacts with a server to request and receive services and/or data. A client application can facilitate interactions between users, servers, etc. For example, the client application may be a mobile application (e.g., WhatsApp™, Instagram™, etc.), a web application (e.g., JavaScript), or a desktop application (e.g., Slack™ desktop application), which may or may not be provided by a communication platform, a database interface (e.g., such as an application that presents a SQL or other database interface), etc. In some examples, individual client computing devices can have an instance or versioned instance of the client application that can be downloaded from an application store, accessible via the Internet, or otherwise executable by the processor(s) 112 to perform operations as described herein. That is, the client application 128 can be an access point, enabling a user computing device to interact with server(s) to access and/or use communication services available via the client application. In at least one example, the client application can facilitate the exchange of data between and among various other user computing devices.

In some examples, the client application may be associated with a software (e.g., a computer program, application software, utility program, operating system, etc.) or other set of instructions that a computing device follows to perform a particular task or series of tasks. Examples of client applications can include database applications (e.g., software used to create, manage, and/or manipulate databases), network applications (e.g., software that facilitated network connectivity, communication, etc.), security applications (e.g., software designed to protect computing devices and data from theft), entertainment applications (e.g., software designed for entertainment purposes such as a video streaming application, music streaming application, gaming application, social media application, podcast application, news or magazine application, comic application, etc.), productivity applications (e.g., software designed to assist users in performing tasks efficiently), financial applications (e.g., software designed to facilitate transactions between users such as a banking application), and the like.

In some examples, the client application 128 may additionally or alternatively comprise instructions executable by one or more processors 112 to provide a user interface 130 (also referred to as a graphical user interface (GUI)). In at least one example, a user can interact with the user interface via touch input, keyboard input, mouse input, spoken input, or any other type of input. The user interface 130 may display UI component(s) associated with an AI assistant generated by the AI assistant management system 102.

In some examples, client computing device(s) 104 may be associated with a database system including one or more application servers that support an application platform capable of providing instances of virtual web applications over the network(s) 106 to any number of client devices. Users may interact with client devices (e.g., view, access or obtain data or other information). In some examples, one or more databases associated with the client application 128 can maintain, on behalf of a user, tenant, organization or other resource owner, data records entered or created by that resource owner (or users associated therewith), files, documents, objects or other records uploaded by the resource owner and/or files, documents, objects or other records automatically generated by one or more computing processes (e.g., by a server associated with client computing device(s) 104 based on user input or other records of files stored in a database). Data and services generated by the client application or client platform may be provided via the network to any number of client devices where instances of the client application may be suitably generated at run-time (or on-demand) using a common application platform that securely provides access to the data associated with the client application.

The client application 128 may generally include at least one processing system, which may be implemented using any suitable processing system and/or device, such as, for example, one or more processors, central processing units (CPUs), controllers, microprocessors, microcontrollers, processing cores, application-specific integrated circuits (ASICs) and/or other hardware computing resources configured to support the operation of the processing system described herein. The application server also includes or otherwise accesses a data storage element (or memory), and depending on the implementation, the memory 114 may be realized as a random access memory (RAM), read only memory (ROM), flash memory, magnetic or optical mass storage, or any other suitable non-transitory short or long term data storage or other computer-readable media, and/or any suitable combination thereof. In exemplary implementations, the memory 114 stores code or other computer-executable programming instructions that, when executed by the processing system, are configurable to cause the processing system to support or otherwise facilitate the application platform and related software services that are configurable to subject matter described herein.

In some examples, a client application 128 can be associated with a source code repository 132. A source code repository 132 is a storage location where source code associated with a client application can be managed, versioned, modified, and/or shared. A source code repository 132 includes tools and infrastructure that enable developers to track changes made to source code, collaborate, and maintain a code base that can be monitored over time. In some examples, the source code repository 132 may include source code files that can be copied and shared. In some examples, a source code repository 132 can include the source code files, a version history of the source code, change logs listing changes made to the source code, branches and tags, metadata for tacking changes to the source code (e.g., commits, developers, timestamps, etc.), access controls and permissions associated with the source code. In some examples, the AI assistant management system may store a copy of the source code so that it is not lost or can be recovered in case of hardware failure or other issues. In some examples, the source code repository 132 may log a time and location of distributed copies of the source code. The source code repository 132 may serve as a centralized hub for managing the source code, facilitating collaboration among developers, maintaining history of changes, and the like. In some examples, a source code repository may be managed using a web-based platform, such as GitHub™, GitLab™, Bitbucket™, a self-hosted server, etc.

Source code (or service code data) may represent an original code written by developers of a client application. The source code defines a functionality and behavior of a client application or service. The source code represents programming code or instructions and logic utilized by the client application. For example, the source code data can include algorithms, data structure, configuration data (e.g., a configuration file that defines database connection parameters), domain logic data, data access, presentation logic (e.g., user interface code), APIs, controllers, data repositories (e.g., a data repository for accessing user data from a database), etc., that enable the client application to perform its intended tasks. Source code data can be compiled or interpreted to run on server(s), providing a desired functionality to end users or other services.

In some examples, the source code repository may encapsulate domain logic (or business logic). Domain logic represents software that encodes real-world business rules that determine how data associated with how data is generated, stored, updated, changed, etc. Domain logic can encompass the algorithms, processes, and rules that are specific to an application's domain. Domain logic can be implemented as part of a client application's source code. In some examples, domain logic can include configuration files that contain settings or parameters that influence the behavior of the domain logic. For example, a financial accounting application may include a source code repository including a configuration file in JSON or YAML format that specifies discount rates or tax rules. To provide another example, an e-commerce application may include domain logic defining a process for adding items to a shopping cart (i.e., what set of rules to follow and in what order).

In some examples, the source code repository may include or store Application Programming Interface (API) data (or API documentation data). In at least one example, the API documentation is stored separate from the source code repository (e.g., it may be maintained as a separate document, file, website, etc. or maintained on a GitHub™ page separate from the source code). API documentation is a set of human-readable instructions for using, interacting, and integrating with an API. The API documentation may include detailed information about an API's available endpoints, methods, resources, authentication protocols, parameters, headers, common requests and responses, and the like. For example, the API documentation may include data related to an overview of the API, including, for example, general information about the API, the purpose of individual APIs and how they can be used. The API documentation may include a list of API endpoints, including their URLs and HTTP methods (e.g., GET, POST, PUT, DELETE, etc.). For example, a read API endpoint to retrieve resources (e.g., PUT/users/{id}), update API endpoint, delete API endpoint, an API endpoint that operates on a collection of resources or a single resource, an API endpoint that is configured to perform a specific action, an API endpoint dedicated to authorization and authentication, API endpoint that receives data from an external service (e.g., webhooks for payment).

In some examples, the API documentation may include descriptions of the required and/or optional parameters for each API endpoint, including query parameters, headers, body data, etc. In some examples, the API documentation may include instructions on how to authenticate and authorize API requests, such as using API keys, OAuth tokens, or other methods. The API documentation may include data related to response formats (e.g., details about the format of the data returned by the API, such as JSON or SML, and explanations of the fields in the response). In some examples, the API documentation may include descriptions of possible error codes or error messages and guidance on how to handle particular errors. In some examples, the API documentation may include one or more sample code snippets (or code examples) in various programming languages illustrating how to make API requests and handle responses. In some examples, the API documentation may include versioning data indicating different versions of the API, including deprecated features and/or backward compatibility. In some examples, the API documentation may include data related to rate limits and/or quotas indicating various restrictions on the number of requests that can be made to the API within a certain time frame. In some examples, the API documentation may include recommendations for how to use the API efficiently and securely, as well as common use cases.

The client application 128 may be configured to embed an AI assistant component 134 into the user interface 130. For example, the AI assistant management system 102 associated with the AI assistant management system 102 can generate an AI assistant component and send the AI assistant component to the client computing device(s) 104 for integration. That is, the AI assistant component 134 may be configured to be automatically integrated into the client application without requiring special code or programming knowledge. In some examples, the AI assistant generation component generates an AI assistant component (e.g., a bundle of files composed of HTML, JavaScript and/or CSS resources). The AI assistant component can be integrated into the client application by the client using a JavaScript script, which can be loaded from an access point provided by the AI assistant management system or otherwise provided by the AI assistant management system.

Users of the client application 128 can interact with the assistant component 134. That is users can request an AI assistant perform a task on behalf of the user.

The client computing device(s) 104 may include a communication interface 140 and input/output devices 142. Similar to communication interface(s) 136, communication interface(s) 140 may include any number of transmitters, receiver, transceivers, wired network interface controllers (e.g., an Ethernet adapter), wireless adapters or another suitable network interface that supports communications to/from the network 106. In some examples, the communication interface(s) 140 can facilitate communication via WebSockets, Application Programming Interfaces (APIs) (e.g., using API calls), Hypertext Transfer Protocols (HTTPs), etc. Input/output devices 142 may be similar to input/output devices 138 discussed above.

It will be appreciated that the terms “datastore,” “database,” “repository,” and “network database” may be used interchangeably in areas of the present disclosure. As used herein, the terms “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like. Moreover, data may be transmitted, received, or otherwise exchanged as individual “data objects” comprising interrelated data. Data objects may constitute single bits of data or large quantities of interrelated data, such as substantive data (e.g., the underlying content to be conveyed through a communication) and associated metadata (e.g., data not otherwise considered to be substantive data, encompassing characteristics of the substantive data and/or the relevant exchange (e.g., the identity of the user sending the data, the identity of the user receiving the data, the time/date when the data was sent, formatting to be associated with the exchanged substantive data, the file type of the data object, and/or the like).

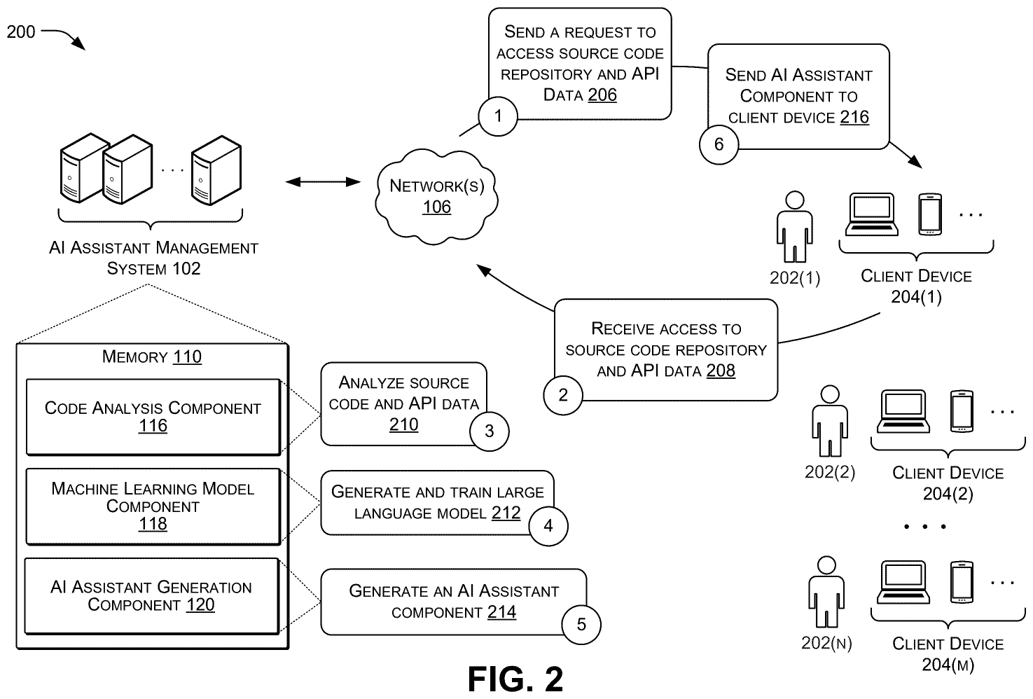

FIG. 2 is a view of an example system 200 usable to implement example techniques described herein to facilitate generation of a trained LLM and AI assistant component. In some examples, the system 200 can include users 202(1), 202(2), . . . 202(n) (collectively “users 202(n)) to interact using client devices 204(1), 204(2), . . . 204(m) (collectively “client devices”) with an AI assistant management system 102 via network 106.

At operation 206 (indicated by “1”), the AI assistant management system 102 may send a request to a client device 204(1) for source code data (e.g., access a source code repository) and/or API documentation. The client device 204(1) generally represents an electronic device coupled to the network 106 and that may be utilized by a user 202(1) to access an instance of a client application (e.g., client application 128) executed on or at the client device 204(1). In practice, the client device 204(1) can be realized as any sort of personal computer, mobile telephone, tablet, or other network-enabled electronic device coupled to the network 106 that executes or otherwise supports a web browser or other client application that allows a user to access one or more GUI displays provided by the client application. The client device 204(1) is capable of receiving input from the user of the client device 204(1). Some implementations may support text-to-speech, speech-to-text, or other speech recognition systems, in which case the client device 204(2) may include a microphone or other audio input device that functions as the user input device, with a speaker or other audio output device capable of functioning as an output device.

The illustrated client device 204(1) may execute or otherwise support a client application that communicates with an application platform provided by a processing system at an application server in order to access an instance of the application using a networking protocol. In some implementations, the client application is realized as a web browser or similar local client application executed by the client device 204(1) that contacts the application platform at the application server using a networking protocol, such as the hypertext transport protocol secure (HTTPS). In this manner, in one or more implementations, the client application may be utilized to access or otherwise initiate an instance of a virtual web application, where the virtual web application provides one or more web page GUI displays within the client application that include GUI elements for interfacing and/or interacting with records or other data.

To provide a non-limiting example, the client device 204(1) may be associated with a communication platform or system that enables users to exchange posts, images, videos, links, documents, etc. via an application. The communication platform may desire to add an AI assistant to their application to enhance user experience. For example, an AI assistant customized to the particular communication platform may be configured to assist users in performing a variety of tasks, provide information, etc. The AI assistant may provide answers to questions regarding the communication platform's policies, products, and/or services particular to the communication platform. The AI assistant may be configured to retrieve data (e.g., posts, messages, videos, images, etc.) for users based its understanding of communication platform and content individual users have access to. An AI assistant may be configured to draft, send messages or emails, etc. based on the preferences of the particular communication platform and/or users of the communication platform.

At operation 208 (indicated by “2”), the AI assistant management system 102 may receive the source code data (or otherwise receive access to the source code) and API documentation from one or more computing devices (e.g., client device 204(1)). As discussed above, source code data may include a plain text listing of commands that are compiled into an executable computer program (e.g., software including an operating system(s), application software, etc.). Source code may represent an original code written by developers of a client application and defines a functionality and behavior of a client application or service. That is, the source code data can be programming code or instructions and logic utilized by the client application associated with the client device 204(1). For example, the source code data can include algorithms, data structure, configuration data (e.g., a configuration file that defines database connection parameters), domain logic data, data access, presentation logic (e.g., user interface code), APIs, controllers, data repositories (e.g., a data repository for accessing user data from a database), etc., that enable the client application to perform its intended tasks. Source code data can be compiled or interpreted to run on server(s), providing a desired functionality to end users or other services.

In some examples, the AI assistant management system 102 may receive a file(s) containing the source code (e.g., via email, Dropbox, OneDrive, etc.), a link to a source code repository (or a link to download the source code), receive access from a system, platform or service that can host a source code repository online (e.g., GitHub/GitLab/Bitbucket). In some examples, the AI assistant management system 102 may receive a compressed file (e.g., .zip) containing the source code data. In some examples, the source code data may be versioned (e.g., the latest version of the source code or a historical version).

The AI assistant management system 102 may additionally receive API documentation (or otherwise receive access to the API documentation). As discussed above, the API documentation may include detailed information about an API's available endpoints, methods, resources, authentication protocols, parameters, headers, common requests and responses, and the like. The API documentation may be received separately from the source code. In some examples, the AI assistant management system 102 may generate API data based at least in part on the received source code data, as discussed further below.

In some examples, the AI assistant management system 102 may receive source code data and/or API documentation that is encrypted so that only an authorized entity can access and/or view the information. In some examples, the source code data may be transmitted over network 106 using secure shell (SSH) and Transport Layer Security (TLS) techniques. In some examples, the source code repository may be encrypted and decrypted using public and private keys (e.g., using asymmetric encryption techniques). The AI assistant management system 102 may receive the encrypted source code data along with a decryption key (concurrently or subsequent to the sending the encrypted source code data) from the client device 204(1).

In at least one example, the host system may receive at least a portion of the source code in the source code repository. For example, a portion of the source code may include data protected by a trade secret laws and the client may want to keep some portion of the source code private. In some instances, a client (e.g., a developer) may clone or copy the source code repository and store it in a database (e.g., on a local machine). Clients may continue to make changes to the source code (e.g., when creating a new feature for the client application) and create a branch to work on the new feature or fix a bug. Changes made to the codebase can be pushed to the remote repository and merged into the main branch.

In some examples, a client application may have a structured codebase where the domain logic and business logic are separated from infrastructure code, data access, user interface components, etc. This separation can be achieved through design patterns such as model-view-controller (MVC), domain-driven design (DDD), and service-oriented architecture (SOA). In the case of an MVC, the MVC enables the data associated with an application to be separated between frontend and backend code. That is, source code associated with a client application may be divided into front end components responsible for displaying data to a user via a graphical user interface and backend components associated with business logic, APIs, collection of services, and rules of the application (e.g., how data is retrieved from a database, how data is processed and updated, etc.). In some examples, the frontend component(s) of a client application are configured to incorporate or embed an AI assistant component into a UI of the client application.

In some examples, the AI assistant management system 102 may receive data other than source code data associated with a client application. Additional data may be utilized to help train a customized LLM particular to the client application that can understand the nuances of the client's business. For example, AI assistant management system 102 may receive user data (e.g., user account data, user setting data, user preference data, etc.), transactional data (e.g., order histories including records of purchase, sales, billing information, etc.) historical data related to usage patterns (e.g., data indicating how an application is used over time), performance metrics indicating load times, responses times, errors rates, etc. In some examples, the AI assistant management system 102 may receive configuration data related to the client applications system settings such as configuration files, application setting data, etc. In some examples, the AI assistant management system 102 may receive media files such as images, videos, audio files used within the application, text content (e.g., posts, comments, and other text-based content). In some instances, the AI assistant management system 102 may receive documentation and manual data such as user guides, developer documentation including API references and code examples, historical release notes associated with the client application, etc. In some examples, the AI assistant management system 102 may receive integration data indicating API data related to third-party integrations, API usage, external service data, webhook data (e.g., logs of webhook events, payloads, and responses).

In some examples, prior to receiving the access to the source code repository, the AI assistant management system 102 may request the client sign up for a user account with the AI assistant management system 102. That is, the AI assistant management system may prompt the client to create a user profile, password and provide additional information including, for example, contact information, business information, ownership details, payment information (e.g., in order to start a subscription with the AI management system), and the like. In some examples, a client may subscribe to the AI assistant management system 102, which enables the client (or customer) to access services provided by the AI assistant management system (e.g., the generation, training, and utilization of a customized ML model).

To continue the particular non-limiting example provided above at operation 206, the AI assistant management system 102 may receive a source code repository and/or API documentation from a communication platform or system. The source code data repository may indicate the various frameworks used by the communication platform, such as the HTML/CSS for structing and styling their application and webpages, databases that are used, the code structure, etc. API documentation defining the available operations of the communication platform, the expected request formats, and the structure of the responses. For example, the source code may include webhook data (e.g., defining an automated HTTP-based callback function that facilitates event-driven communication between 2 or more APIs) associated with events such as when a user sends a message, comments on a post, posts a new status update, posts a new photo or video, gains a new follower, and the like.

At operation 210 (indicated by “3”), a code analysis component 116 associated with the AI assistant management system 102 analyzes source code data (or simply “source data” or “code data”) and the API documentation data (or simply “API data”). The code analysis component 116 may analyze the source code data using static code analysis tools and techniques without executing a program or application. In some examples, the code analysis component 116 analyzes the source code data in order to identify and understand the domain logic (or business logic). Domain logic represents software that encodes real-world business rules that determine how data associated with a client application is generated, stored, updated, changed, etc. Domain logic can encompass the algorithms, processes, and rules that are specific to an application's domain. For example, in the case of a banking application, domain logic can include operational data related to how interest is calculated, how a transaction is processed, how an account number is validated, and the like. Domain logic can be implemented as part of a client application's source code. In some examples, domain logic can include configuration files that contain settings or parameters that influence the behavior of the domain logic. For example, a financial accounting application may include a source code including a configuration file in JSON or YAML format that specifies discount rates or tax rules. To provide another example, an e-commerce application may include domain logic defining a process for adding items to a shopping cart (i.e., what set of rules to follow and in what order).

The code analysis component 116 can analyze source code in order to identify existing functionalities within the source code and understand the client application's business logic. The code analysis component 116 may be configured to analyze source code. In some examples, the code analysis component 116 can scan the source code for potential errors, performance or other quality attributes, security vulnerabilities within the source code, and/or adherence to code standards. In some examples, code analysis component 116 may analyze the source code and detect the presence of potential runtime errors, dead code (e.g., code that is never executed), repeated code (or cloned code), software bugs or issues, syntax errors (e.g., mistakes in code that prevent it from running correctly), performance issues (e.g., code that is inefficient and may leads to performance bottlenecks), etc.

The code analysis component 116 may analyze the APIs and API endpoints and determine how an application or system interacts with other systems. In some examples, the code analysis component 116 can leverage one or more machine learning models to identify existing functionalities of a client application by analyzing the source code. For example, the code analysis component 116 may parse the source code (e.g., using an Abstract syntax tree (AST) parser) to convert the source code into a tree structure (e.g., an AST) that represents its syntax. The code analysis component 116 may then determine a framework associated with the source code and/or determine which libraries are used in the source code (e.g., Flask, Django for Python, Express for JavaScript, Spring for Java, etc.).

In some examples, the code analysis component 116 may generate API data based at least in part on the received source code data. For example, in the case where the AI assistant management system 102 receives source code data and not API documentation data, the code analysis component 116 may automatically generate API documentation data based on analyzing comments and/or annotations in the source code (e.g., using one or more machine learning models).

In some examples, the code analysis component may identify regular expressions in the source code (e.g., \hat{ }https?://matches URLs starting with “http://”) and/or string matching to detect key statements and other data for particular libraries of the source code. In some examples, the code analysis component 116 may be configured to extract data from API documentation within the codebase. The code analysis component 116 may determine API endpoints associated with the source code, which can vary between different applications and platforms. The code analysis component may identify HTTP methods (e.g., GET, POST, PUT, DELETE, etc.) used in various API endpoints. For example, the code analysis component 116 may identify a “GET/user/{userId}” API endpoint that retrieves bask information about a user based on their unique user ID), a “GET/user/{userId}/posts” API endpoint that retrieves posts made by the user identified by their unique ID, a “GET/user/{userId}/comments” API endpoint that retrieves the comments made on a particular post identified by its unique ID, a “POST/users” API endpoint that creates a new user account (or object) with a unique ID, “PUT/users/{userId}” API endpoint that can update the details of a particular identified by the “userid”, “DELETE/users/{userId}” API endpoint that can delete a user account and/or generate a confirmation message indicating that the user account has been deleted, and the like. The code analysis component may analyze configuration files (e.g., files used to configure the parameters and initial settings of a client application or program) and identify routing configurations file(s) (e.g., file(s) that contain properties used by the application router).

The code analysis component may analyze various types of data that can be utilized to train a customized large language model (LLM). For example, the code analysis component may analyze metadata associated with source code. Source code metadata may include, for example, development metadata indicating authorship, dates of release, revision history etc., and/or intrinsic metadata (or embedded metadata) extracted from the source code repository itself. The code analysis component may extract code structure data. For example, the code analysis component may extract class definitions representing blueprints for creating objects, defining attributes, and behaviors in object-oriented programming, method and function definitions representing blocks of code that perform particular tasks, variable declarations that reserve storage locations for data, module and package organization associated with logical grouping of related code files into modules and packages, and the like. In some examples, the code analysis component 116 may extract and analyze inline comments, block comments, documentation comments, etc. in the source code repository that explain particular lines or sections of the source code. In some examples, the code analysis component 116 may analyze dependencies in the source code (e.g., import statements representing lines of code that bring in external libraries, modules, or packages needed by the client application, external API calls that are invoked from external services or libraries, and the like).

In some examples, the code analysis component 116 may analyze the control flow (or flow of control) of the source code (i.e., the order in which individual statements, instructions, or function calls of a client application are executed or evaluated). For example, the code analysis component may analyze conditional statements (e.g., code constructs that execute different blocks of code based on certain conditions (e.g., if, else, switch, etc.)), loop structures in the source code (e.g., constructs that repeat a block of code multiple times (e.g., for, while, loops, etc.)), exception handling representing code that manages errors or exceptions to ensure the client application can handle unexpected situations (e.g., try, catch, finally, etc.). The code analysis component may analyze the various data types and structures associated with the source code data (e.g., primitive data types built into programming language, composite data types representing complex data structure that group multiple values (e.g., arrays, lists, sets, etc.), custom data types representing user defined data structured (e.g., classes), and the like).

In some examples, the code analysis component 116 may analyze the logic data and/or algorithms associated with the source code. For example, the code analysis component may identify mathematical operations in the source code that perform arithmetic and other mathematical calculations, data processing algorithms that manipulate data, identify sorting and searching algorithms that define methods for organizing and finding data within the client application. In some examples, the code analysis component may identify configuration and settings data associated with the source code. For example, constants or other fixed values that do not change throughout the source code, configuration files (or external files) that are used to set parameters and settings for a client application (e.g., JSON, XML, YAML, etc.). In some examples, the code analysis component may identify security-related information associated with the source code data. For example, authentication mechanisms used to verify the identity of users or systems of the client application, encryption and decryption methods for securing data by encoding and coding it, etc.

In some examples, the code analysis component 116 may analyze the source code using one or more machine learning (ML) models. The code analysis component 116 may leverage large language model(s) to extract relevant information associated with the source code and APIs. For example, a ML model may be trained (using supervising and/or unsupervised learning) to extract, identify, and/or understand the source code, identify patterns from previous code reviews and/or a client's particular source code. For example, a ML model can predict missing lines or blocks of code based on determining a context of the code that is present (e.g., using pattern recognition). That is, a ML model can use various ML algorithms (e.g., decision trees, neural networks, support vector machines, etc.) to detect and learn patterns and make predictions as to the intent and purpose of the source code.

To continue the particular non-limiting example provided above at operations 206 and 208, the code analysis component 116 may analyze source code data associated with the communication platform and identify various API endpoints. For example, the communication platform may have a first endpoint that retrieves basic information about a user (e.g., GET/user/{userId}), a second endpoint configured to retrieve posts made by a user identified by their unique ID (e.g., GET/user/{userID}/posts), a third API endpoint configured to retrieve comments made on a particular post identified by its unique ID (e.g., GET/user/{userID}/comments), and the like.

At operation 212 (indicated by “4”), a machine learning (ML) model component 118 associated with the AI assistant management system 102 can generate and train and/or fine-tune a large language model based at least in part on the analysis of the source code. As noted above, data related to how users interact with the client's application can be utilized to generate training data that can then be used to train a customized LLM. The customized LLM can then be used in association with an AI assistant component (e.g., a chat bot) that understands the intricacies of a client's business, possessing familiarity with both the source code and the entire spectrum of available services and APIs.

The ML model component 118 may fine-tune a base LLM to perform tasks specific to a client application. The ML model component 118 may fine-tune the LLM using training data generated based in part on the analysis of the source code and API documentation. In some examples, the ML model component 118 may generate and train a ML model that is suitable for the particular client application. For example, the model may be a supervised learning model (e.g., regression model, classification model) or unsupervised learning model (e.g., clustering model) depending on a type of client application (e.g., a logistic regression model for predicting a rate at which a customer will leave a platform, a decision tree for rule-based classification, a time series model for predicting sales forecasting, etc.). In some examples, the ML model component 118 may generate and train multiple models for a particular client application based on the desired tasks to be completed. For example, the ML model component 118 may generate and train an LLM that is configured to perform a first type of task (e.g., answer questions about particular products and/or services of a business) and may generate an additional model for the business that is configured to predict outcomes (e.g., a random forest machine learning algorithm that can classify an image).

The ML model component 118 may generate training data set(s) based in part on the analysis of the source code data (e.g., as discussed above with regard to operation 210). For example, the machine learning model component 118 may generate a training data set based at least in part on using the source code data, domain logic (e.g., a set of rules, computations, processes related to the software application associated with the functionalities of the client application) and/or business logic (e.g., broader rules and workflows that dictate the behavior of an application based on a particular requirements of individual applications) extracted from source code data or other data associated with a client application. The ML model component 118 can generate training data based on domain logic data of a client application. The training data may be generated based on data associated with the core functionalities and rules particular to a client's application. For example, in the context of a banking application, training data can be based on data related to operations such as calculating interest, processing transactions, and validating account numbers. To provide another non-limiting example, in the context of a healthcare application, platform, or system, a healthcare training data may be generated based on data related to patient record management, appointment scheduling, medical billing, and the like.

In some examples, the ML model component 118 may pre-process data associated with source code. For example, the ML model component 118 may reformat the source code data in order to remove comments that do not provide context to understand the source code, ensure consistent use of spaces and tabs within the source code, remove unnecessary spaces or line brakes, etc. In some examples, the ML model component 118 may transform the source code data and business logic data associated with a client application into tokens such as keywords, operators, identifiers, symbols, etc. In some examples, the ML model component 118 may parse the code into AST in order to understand the syntactic structure of the code.

As discussed above, business logic data may be associated with rules, processes, and operations that define how a business associated with an application operates. The ML model component 118 may generate a training dataset based in part on transforming the source code data, business logic, domain logic, etc. into a structured format that encapsulates the business rules/logic. For example, in the case of an e-commerce application, the ML model component 118 may generate a training dataset based on business logic data associated with the particular c-commerce application (e.g., a rule that indicates orders from customers of group A are to be processed using discount B when exceeding amount C). In some examples, the ML model component 118 may standardize the format of the domain logic data so that dates, numbers, etc. have a consistent data format (e.g., standardize text to a common Unicode format). The ML model component 118 may tag or label the domain logic data in order to categorize it into different types of domain logic. The tokenized data may be utilized to train a customized LLM.

In some examples, the ML model component 118 may generate a training dataset, validation dataset, and test dataset to evaluate a performance of the customized LLM. Additional types of data can be utilized to train a customized large language model (LLM). The ML model component 118 may generate a training dataset based on a variety of data received from client device 204(1). For example, the training data set may be generated based on the data analyzed by the code analysis component as discussed above. In some examples, the ML model component may generate training data based at least in part on historical data or other type of data related to the client's business that was provided by the client device 204(1), for example.

To continue the particular non-limiting example provided above at operations 206, 208, and 210, the machine learning model component 118 can fine tune a particular LLM for the communication platform based at least in part on the analyzed source code data and API data. The customized LLM can be fine-tuned to generate an executable plan containing information about the sequence of API calls, instructions on how to extract relevant information from responses, what data transformations to apply, what portions of data is needed for each subsequent API call, etc. Since the customized LLM has been fine-tuned on the codebase and APIs associated with the communication system, the LLM can decipher which API calls to make even if it is not explicitly provided in the API documentation. For example, though the original source code data may include an API call GET/post/{postId}/additionalinfo, the LLM can interpret this to mean GET/post/{postId}/comments based on the service logic and an understanding that comments are populated as part of this API endpoint.

At operation 214 (indicated by “5”), an AI assistant generation component 120 associated with the AI assistant management system 102 can generate an AI assistant component. The AI assistant component represents a software component capable of providing or otherwise supporting an automated agent or chatbot service. That is, the AI assistant component may be associated with an AI assistant, chatbot, or other automated interactive tool that can receive user input (e.g., exchange chat messages or provide conversational responses, which may include text-based messages that include plain-text words, and/or rich content messages that include graphical elements, enhanced formatting, interactive functionality, etc.). A generated AI assistant component may be provided to a client application for integration. That is, an AI assistant component may be configured to be integrated into a client application or platform so that it is part of a UI.

In some examples, the AI assistant component may provide the AI assistant component with a set of instructions that can be executed by the client application (e.g., a JavaScript™ script). The set of instructions may enable the AI assistant component to be integrated into a UI of the client application. For example, the AI assistant component may be sent to the client computing device along with HTML component tags and/or elements that are configured to display and/or accept data from a user of the client application. HTML component tags may include component tags or attributes that provide additional instructions associated with integrating the AI assistant component. For example, an ID attribute for a component tag can uniquely identify the AI assistant component. A rendered UI component tag attribute can specify whether or not the AI assistant component is configured to be rendered on the client UI. A style component can specify a particular style of the AI assistant component. The AI assistant component may be associated with instructions that define how the AI assistant (or chatbot) is to be displayed, how data is to be collected from a user (e.g., via a text field, text area, etc.). The AI assistant component may be associated with instructions that define what message is displayed in association with the AI assistant. For example, a caption component may be associated with the AI assistant component and can instruct the user to “Give me a task to perform,” ask “what do you need help with?” or “What can I assist you with?” and the like. The AI assistant component may be associated with a text box that allows a user to interact with the AI assistant. For example, a user may input a request in the form of text, voice recognition, etc. The AI assistant component may be configured to interact with the customized LLM generated and trained by the machine learning model component 118.

The AI assistant generation component may assign a unique identifier to the generated AI assistant component. The identifier may correspond to a target HTML element that enables the AI assistant management system 102 to toggle the AI assistant component on and off. This enables the AI assistant management system 102 to maintain control over the AI assistant component. For example, the AI assistant management system 102 may allow clients to subscribe to an AI assistant service that provides personalized LLM chatbot or other AI assistant that generates a conversational response. At the end of the subscription period (or if the client cancels the subscription), the AI assistant management system 102 can toggle the AI assistant component off, ending the service.

The AI assistant generation component 120 may generate an AI assistant component that that can include custom objects and/or standard objects. For example, using the analyzed source code data, the AI assistant generation component 120 may generate or otherwise define a new AI assistant chatbot that includes a custom field to be added to or associated with the client application. The AI assistant generation component may generate an AI assistant component using one or more standard objects and/or define a new custom object type that includes one or more new custom fields. The AI assistant generation component 120 may also store or otherwise maintain metadata that defines or describes the fields, process flows, workflows, formulas, algorithms, business logic, structure and other components that that may be associated with a particular client application AI assistant component.

At operation 216 (indicated by “6”), the AI assistant management system 102 sends the AI assistant component to client device 204(1) for integration. The code or other programming instructions associated with the client application, platform, virtual web application, etc. may be configurable to incorporate or otherwise integrate the AI assistant component into the client application, platform, or virtual web application. In at least one example, the AI assistant component may be integrated with or otherwise incorporated as part of the client application, or be realized as a separate or standalone process, application programming interface (API), software agent, or the like that is capable of interacting with client devices independent of the client application.

A fine-tuned LLM associated with the integrated AI assistant component may incorporate or otherwise reference a vocabulary of words, phrases, phonemes, or the like associated with a particular language that supports conversational interaction with the user of the client device. For example, the vocabulary may be stored or otherwise maintained in a memory 110 associated with the AI assistant management system 102 (e.g., a database associated with the AI assistant management system 102) and utilized by the AI assistant component to provide speech recognition or otherwise parse and resolve text or other conversational input received via a GUI or chat window. The AI assistant component may generate or otherwise conversational output (e.g., text, audio, and the like) to the client device for presentation to the user 202(1) (e.g., in response to a received conversational output). In some examples, a large language model associated with the AI assistant component may be configured to answer questions about a client's business due to being trained on the source code received from the client.

To continue the particular non-limiting example provided above at operations 206, 208, 210, and 212, the AI assistant component generated for a communication platform may utilize a customized LLM that have access to more applicable information for a wide range of potential input prompts. That said, the LLM may have context or other understanding of information or situations that may be particular to the communication platform. The AI assistant may output more accurate and/or contextually relevant responses to users of the particular communication platform.

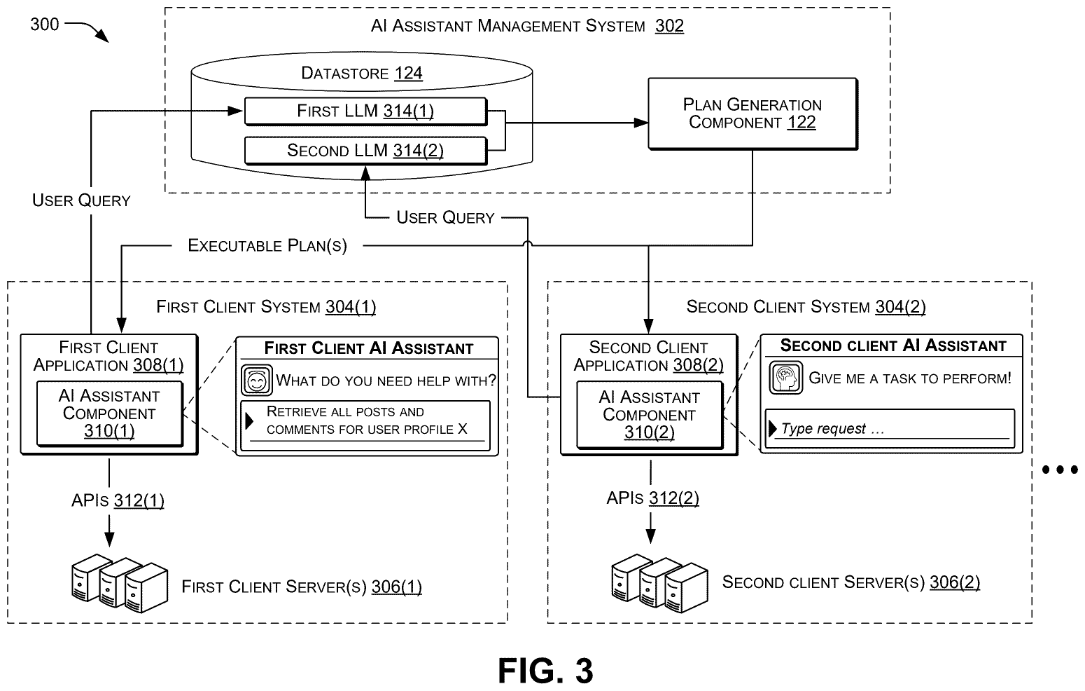

FIG. 3 illustrates an example environment 300 for generating an executable plan. The example environment 300 may include an AI assistant management system 302, a first client system 304(1), and a second client system 304(2). Though two client systems are shown, more or less client systems may be in included in the example environment.

The AI assistant management system 302 may be the same or similar to the AI assistant management system 102 discussed above in relation to FIGS. 1 and 2. In some examples, the AI assistant management system may be a cloud-based service. That is the AI assistant management system 102 may be provided over a network (e.g., network 106) rather than being hosted on a local server or personal computer. In some examples, the AI assistant management system 102 may provide or deliver a software application over a network (e.g., software as a service (SaaS).

The AI assistant management system 302 may include a datastore 124 and a plan generation component 122. The datastore 124 may be configured to store customized ML models (e.g., first LLM 314(1) and second LLM 314(2)) that have may have been trained and/or fined-tuned to comprehensively grasp a client's business dynamics and existing functionalities within individual client's source code. The first and second LLMs parse or otherwise analyze the textual content of the user input using natural language processing (NLP) to identify the intent or other action desired by the user based on the content, syntax, structure and/or other linguistic characteristics of the user input. The first LLM 314(1) and second LLM 314(2) are configured to understand the existing capability of each respective client application are against user requests.

In some examples, individual client systems (e.g., first client system 304(1) and second client system 304(2)) can be associated with a database shard within datastore 124 that stores data related to a particular user account for that client system. For example, a database shard may store source code data and/or a customized LLM that is trained based in part on that source code data.

In some examples, the first client system 304(1) may be associated with a first client application 308(1) and the second client system 304(2) may be associated with a second client application 308(2). As discussed above in relation to FIGS. 1 and 2, the client application can be any type of software program configured to run on a client device. A client application can facilitate the exchange of data between and among various computing devices. The first client application 308(1) can be associated with a first AI assistant component 310(1) configured to receive user input. The second client application 308(2) can be associated with a second AI assistant component 310(2). The first client application 308(1) and the second client application 308(2) can be a mobile application, a web application, a desktop application, etc. which can be provided by a communication platform or which can be an otherwise dedicated application. Individual user computing devices associated with the environment 300 can have an instance or versioned instance of the client applications, which can be downloaded from an application store accessible via the Internet, or otherwise executable by one or more processors to perform operations as described herein.

A client application can be an access point, enabling user computing devices to interact with an AI Assistant (or chatbot) that has been generated and trained by the AI assistant management system 102 on behalf of the client. The first client application 308(1) includes an AI assistant component that is configured to present an AI assistant (or chatbot) and the second application 308(2) may be include a different AI assistant component that is configured to present a different AI assistant, as shown in FIG. 3. The AI assistant can receive input text data or other textual content.

The AI assistant component 310(1) and 310(2) may be configured to receive or otherwise obtain a conversational input from a user of client computing device associated with a client application. Upon receiving a user query, the AI assistant component 310(1) associated with the first client application 308(1) may send the user query to the AI assistant management system 102 for plan generation. For example, as shown in FIG. 3, the AI assistant management system 102 may receive from AI assistant component 310(1) associated with the first client application 308(1), a natural language query to “retrieve all posts and comments for user profile X.”

Based at least in part on receiving the user query from the AI assistant component associated with the client application, the AI assistant management system 302 may generate an executable plan (e.g., using plan generation component 122 and a fine-tuned model). As discussed above, an executable plan is a structured strategy or series of steps configured to achieve a goal or carry out a particular task, depending on the user query request. An executable plan may outline a list of steps that are to be performed and in what order. For example, an executable plan may outline a plan of actions including particular API calls and endpoints. The AI assistant management system 102 may generate a first executable plan based at least in part on using the first LLM 314(1) that has been fine-tuned on data related to various APIs 312(1) (e.g., REST endpoints) that may be particular to the first client application 308(1) and the AI assistant management system 102 may generate a second executable plan based in part on using a second LLM 314(2) that has been fine-tuned on APIs 312(2) (e.g., REST endpoints) that may be particular to the second client application 308(2). For example, the AI assistant management system may use static code analysis techniques to fine-tune an LLM (e.g., the first LLM 314(1)) based API endpoints including, for example, a first API endpoint configured to retrieve basic information about a user based on their unique ID, (e.g., GET/user/{userId}), a second endpoint configured to retrieve posts made by a user identified by their unique ID (e.g., GET/user/{userID}/posts), a third API endpoint configured to retrieve comments made on a particular post identified by its unique ID (e.g., GET/user/{userID}/comments).

The executable plan may be generated based in part on identifying or otherwise determining a current objective or intent of the user. For example, a user may request the AI assistant (or chatbot) perform a task such as “find my 10 most engaging friends,” “give me the specifications of this item,” “retrieve all the posts and comments for user profile X,” and the like. In response to the user request, the plan generation component may automatically generate an input prompt for an executable plan that corresponds to the intended action associated with the current user objective utilizing a trained LLM customized for the particular client application. The plan generation component 122 may generate an executable plan that includes steps to access various REST endpoints associated with the client application and combine the results to formulate an appropriate response. The plan generation component 122 may then send the executable plan to the appropriate client system for execution by the AI assistant component. That is, the client system may be configured to execute the plan and present results to the user.

Based on receiving the user query from a user computing device associated with the first client system 304(1), the AI assistant management system 102 may generate an executable plan containing information about the sequence of required API calls, instructions indicating how to extract the relevant information from the responses, what data transformations to apply, and which pieces of information are needed for each subsequent API call. For example, based in part on receiving the user query “retrieve all posts and comments for user profile X,” the plan generation component 122 may generate the following executable plan based at least in part on using the first LLM 314(1): (a) call API endpoint 1 to fetch the target user's information, (b) call API endpoint 2 to fetch the user's posts, and (c) for individual posts retrieved from endpoint 2, call API endpoint 3 to fetch the comments on that post. This executable plan defines a sequential process that is executed by the first client system 304(1) in order to display posts and comments associated with “user profile X” as requested by the user. In some examples, the executable plan can be executed by one or more back-end servers associated with the client system.

In some examples, the first LLM 314(1) is configured to decipher which API endpoints to include in the executable plan even if it is not explicitly recited in the client's source code or API documentation. That is, since the first LLM 314(1) is familiar with the source code of the first client application 308(1), not just the API endpoints, the first LLM 314(1) is able to decipher which API calls to make even it is not explicitly stated in the API documentation provided to the AI assistant management system 102. For instance, if instead of the API call “GET/post/{postId}/comments,” the AI assistant management system 102 had received source code or API documentation containing API call “GET/post/{postId}/additionalinfo, the first LLM 314(1) is fine-tuned to determine that somewhere in the source code (or service logic), the comments are populated as part of this endpoint. Thus, it can trigger the call and extract the comments from the result.

In some examples, at least a portion of the executable plan may be executed by the AI assistant management system 302. For example, one or more steps of the executable plan may be associated with operation(s) that require significant computational resources, e.g., due to the complexity of an operation. For instance, one or more steps of the executable plan may require combining large amounts of data from multiple sources or endpoints, may require time-consuming calculations, complex data transformations (e.g., aggregating, sorting, filtering large amounts of data), and the like. CPU-intensive operations can cause the AI assistant component associated with the client system to perform less effectively and worsen the user experience due to slower response times, increased latency, potential dropped tasks, tasks being placed in a queue, crashes or freezes, increased power consumption, etc. In some examples, the AI assistant management system may receive a request from the AI assistant component associated with the client system (e.g., first client system 304(1)) to execute at least a portion of the executable plan in order to reduce CPU load on the AI assistant component. Responses generated by the AI assistant management system 302 are sent to the AI assistant component for presentation via the UI.

In some examples, the AI assistant management system 302 may perform data transformations on behalf of the AI assistant component associated with the client system. For example, based on receiving a user request to aggregate data from multiple sources, the AI assistant management system may generate an executable plan that includes calling a first endpoint, calling a second endpoint, and combining data retrieved from both API endpoints into a single, cohesive response. For example, in the case of a client system that is associated with a travel booking platform, application, etc., a user associated with the client system may request that the AI assistant provide available flights and hotel options for a particular destination (e.g., the user may type “give me flight options and hotel options for Spokane to Seattle between August 11 and 13” into a text box associated with the AI assistant component). In this particular example, the client system may send the user query to the AI assistant management system 302. The AI assistant management system 302 may generate an executable plan based in part on the user query and a customized LLM that has been trained (or fine-tuned) based in part on source code and API documentation data associated with the particular client system. The executable plan may include a first API endpoint (e.g., GET/flights/search) that returns a list of flight options including one or more additional parameters (e.g., origin location of Spokane, WA, destination location Seattle, WA, departure date Aug. 11, 2024 and return date Aug. 13, 2024) and a second API endpoint (e.g., GET/hotels/search) that returns a list of hotels including different parameters (e.g., destination, check in date, check out date). The AI assistant management system may combine, mesh, or otherwise interweave the results from both endpoints into a single result (e.g., using a separate endpoint that calls both of these APIs). The AI assistant management system sends the result to the AI assistant component associated with the client system for presentation. In some examples, meshing data from multiple sources may be a CPU-heavy task, particularly when a large amount of data (e.g., several megabytes of data) is to be retrieved, sorted, filtered, compiled, etc. Having the AI assistant management system 302 (which may be hosted in a cloud environment) perform data transformations or other CPU-heavy tasks rather than the AI assistant component may reduce potential latency issues.

In some examples, prior to sending the executable plan to the client system, the AI management system may determine whether a task or one or more steps of the executable plan meet or exceed a CPU utilization metric (or a predicted CPU utilization metric). For example, the AI assistant management system 302 may determine that one or more steps of the executable plan have historically been determined to consistently use a threshold percentage of CPU (e.g., 70% or more). A task or step of an executable plan may be predicted to be CPU-heavy based at least in part on analyzing historical data related to task execution time (e.g., how long it takes for a task or step to complete), thread and process activity (e.g., a task that spawns multiple threads or parallel computations, large-scale simulations, etc. may be considered CPU-heavy), instruction time (e.g., the number of instructions executed per a clock cycle can indicate whether a task is CPU-heavy), cache usage (e.g., tasks that utilize a great amount of memory bandwidth can be CPU-heavy), system load, power consumption, etc. Based on this determination, the AI assistant management system may automatically execute one or more steps of the executable plan that are predicted to meet or exceed a CPU utilization metric on behalf of the AI assistant component (e.g., AI assistant component 310(1)) within the client system (e.g., first client system 304(1)) and send the response to the AI assistant component associated with the client system for presentation. To provide a non-limiting example, a step of a generated executable plan may include an API endpoint that processes a large batch of data (e.g., a threshold quantity of data) by filtering, sorting, and transforming the data before storing it in a database may be determined to meet or exceed a CPU utilization metric. In this example, the AI assistant management system may perform the step on behalf of the client system and provide a response to the AI assistant component associated with the client system.

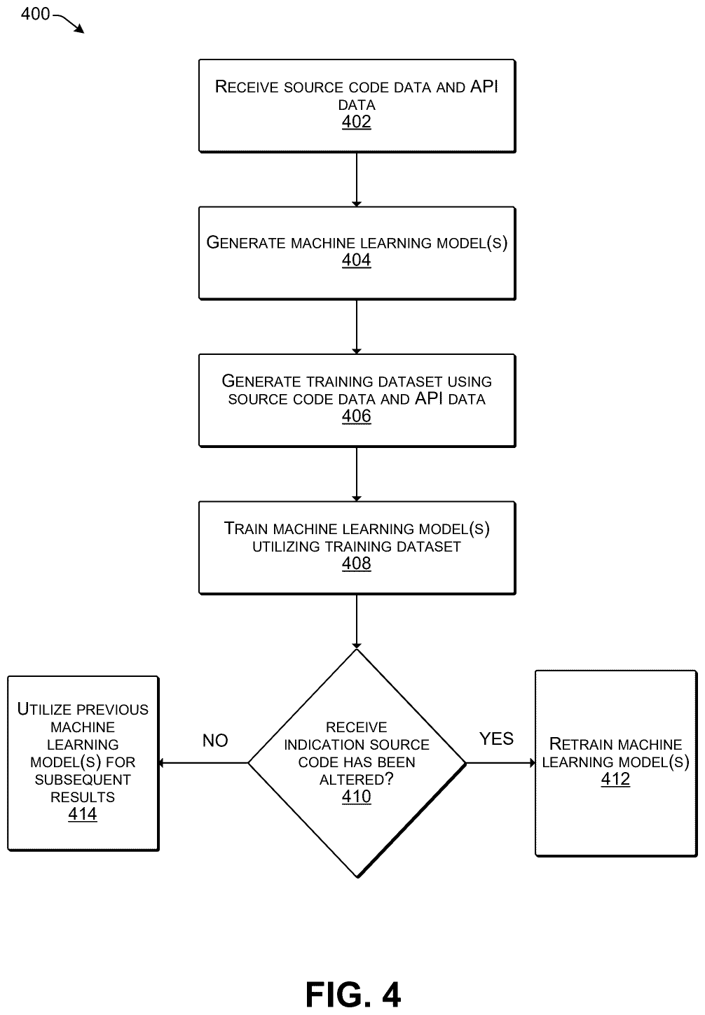

FIG. 4 is a flow diagram of an example process 400 for the generation and training of machine learning models (e.g., large language models) to perform one or more of the processes described herein, according to an embodiment described herein. The order in which the operations or steps are described is not intended to be construed as a limitation, and any number of the described operations may be combined in any order and/or in parallel to implement process 400.

At block 402, the process 400 may include receiving source code data and API data (e.g., API documentation data). The source code data and API data may be received from a client computing device. The source code data and API data may include any of the data described with respect to the source code repository 132, any data described with respect to FIGS. 1-3, and/or any other data that may be utilized to perform the operations described herein. This data may include, for example, domain logic data can include data that encapsulates the core functionalities and rules that are particular to a client application's context. For example, the process 400 may include receiving data related to the business rules, policies, and procedures of the domain particular to the business area associated with the client application. The process 400 may include receiving logic related to how data is processed by a client application, how decisions are made, how various components of the application interact to achieve an intended outcome, and the like. In some examples, the process 400 may include receiving any other types of data related to how a business is managed or utilized by a client application.

At block 404, the process 400 may include generating one or more machine learning models. In at least one example, the machine learning model is a large language model that is trained to predict the next word or sequence of words in a sentence given the preceding context. The large language model can make predictions based on detected patterns the large language model has learned from vast amounts of text data. In some examples, the large language model may be a base large language model that is configured to be fine-tuned (or trained) using source code data that is unique to each induvial client. That is, a base large language model can be fine-tuned on specific data unique to individual client applications. A large language model can configured to perform natural language processing tasks or requests from users, such as sentiment analysis, summarization (e.g., extracting key sentences from a document to create a concise summary), entity recognition (e.g., identify and classify an entity in a text, such as names of users, organizations, locations, dates, etc.), text generation (e.g., generate a draft email), translate text, text classification (e.g., assign a document or snippet of text to a predefined category or topic), and the like.

The machine learning model(s) may utilize predictive analytic techniques, which may include, for example, predictive modelling, machine learning, and/or data mining. Generally, predictive modelling may utilize statistics to predict outcomes. Machine learning, while also utilizing statistical techniques, may provide the ability to improve outcome prediction performance without being explicitly programmed to do so. A number of machine learning techniques may be employed to generate and/or modify the layers and/or models describes herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based machine learning.

In some examples, the machine learning model may be an artificial neural network. An artificial neural network includes various layers that respectively process input data. For example, an artificial neural network includes an input layer, one or more hidden layers, and an output layer. The input layer performs a pre-processing operation on the input data. The hidden layer(s) may perform various processing operations on the output from the input layer. The output layer, in various cases, processes the output from the hidden layer(s). Each layer, in some cases, includes one or more nodes, which are defined by individual operations. In various cases, the hidden layer(s) include nodes that are connected to each other in parallel and/or series. Examples of artificial neural networks include feedforward neural networks, multi-layer perceptrons (MLPs), convolutional neural networks (CNNs), and backpropagation models. In various implementations, the operations performed by the layers and/or nodes within an artificial neural network are defined according to various parameters associated with the analysis of source code date. For example, the parameters may include weights, thresholds, filters, kernels, or other data objects that are utilized to perform operations of the artificial neural network.

At block 406, the process 400 may include generating a training dataset using the source code data and API data. Generation of the training dataset may include formatting the source code data and API data into input vectors for the machine learning model to receive as input. In some examples, the source code data and/or API data can be transformed into a structured format that the machine learning model can understand and process. In some examples, in the case where the machine learning model is a large language model, the training dataset may be generated in a JSON format that consists of a <prompt, completion> pair, where the ‘prompt’ may be a text fragment that the model is to continue and the ‘completion’ is a possible continuation that the model is to learn to produce. In some examples, generating a training data set may include tokenizing the source code data and/or API data into smaller, manageable units (e.g., words, sub-words, characters, etc.) that the model can process. The tokens may then be converted into numerical representations (i.e., vectors) that the model can interpret and understand. This may include creating embeddings or using existing embeddings. In some examples, the source code data can be pre-processed to identify missing values, correct any errors in the source code, replace missing numerical values (e.g., using descriptive statistics to identify features with missing values), identify and remove duplicate source code, convert text to lowercase, etc. In some examples, generating a training data set may include analyzing data from a source code repository provided by a client. The predictive analytic techniques may be utilized to determine associations and/or relationships between explanatory variables and predicted variables from past occurrences and utilizing these variables to predict the unknown outcome. The predictive analytic techniques may include defining the outcome and data sets used to predict the outcome.

At block 408, the process 400 may include training (or fine-tuning) the one or more machine learning models utilizing the training dataset. The machine learning model is fine-tuned so that model adapts to performing tasks particular to and/or unique to a client application. The model may be fine-tuned to generate responses to user queries. Training the machine learning models may include updating parameters, weightings and/or thresholds utilized by the models. In some examples, the training dataset may be split into shards and batches to allow for efficient processing during fine-tuning of the model. Dividing the training data set into batches enables the model parameters to update after processing a certain number of samples rather than after every single sample.

At block 410, the process 400 may include determining whether the source code data has been altered. The source code can be altered for a number of reasons. For example, programmers/developers can continue to make changes to source code in order to fix bugs, add new features, refactor code, etc. As described above, a source code repository may be a centralized, digital storage location where developers can store, share, and collaborate on source code. In some examples, the centralized digital storage location may be a cloud-based repository. For example, the source code repository may be a library stored on a platform such as GitHub™, GitLab™, Bitbucket™, and the like. In some examples, the source code repository may be associated with permissions that enable multiple entities (e.g., computing devices associated with the AI assistant management system) to view or otherwise access the source code data. In some examples, the AI assistant management system may receive temporary access to the source code data, which enables the AI assistant management system to clone the source code repository on a local computing device associated with the AI assistant management system (e.g., creating a local copy of the source code). In some examples, the AI assistant management system may receive permission to automatically receive changes made to a central source code repository (or the main repository) so that changes made to the source code are immediately accessible to the AI assistant management system. In some examples, the AI assistant management system may have limited permissions (e.g., permission to view the central source code repository and not permission to alter it). In at least one example, the AI assistant management system may have limited access to the central source code repository (e.g., some branches of the source code repository may be protected or private or otherwise not accessible to the AI assistant management system).

The source code repository may enable developers to alter the source code without compromising the main source code. That is, rather than applying changes directly to a main branch of the source code, developers can make a copy of the main repository (e.g., by creating a branch) and make changes to the branch. In some examples, the AI assistant management system may receive an indication that a new branch has been created from the main repository. For example, a first branch may be created in order to write codes for a new software feature, a second branch to troubleshoot reported issues, etc. Changes to source code repository may be tracked using a version control system (VCS). The VCS may record modification made to the codebase (e.g., deletion, addition, etc.) enabling the AI assistant management system to view or otherwise determine when changes to the source code data are made and what was altered. In some examples, the AI assistant management system may receive indications of branches that have been merged (e.g., or merge requests) that push source code data changes to the main code base. In some examples, the AI assistant management system may analyze the change logs and history (e.g., the ‘git log’) of what changes were made to the source code. In some examples, the AI assistant management system may generate metadata associated with a time the AI assistant management system accessed the source code repository. In some examples, metadata may be used to track versions of the source code.

In some examples, in the case where the AI management system does not have access to real time changes in the source code, the AI assistant management system may send an automated request for an updated (or new) source code repository and/or new API documentation data at predetermined intervals. For example, the AI assistant management system may send an automatic request for access to a new source code repository every 24 hours, 7 days, 1 month, quarterly, etc. The predetermine time interval may be based at least in part on various factors such as whether developers of a client application are actively making changes to the source code every day due to the implementation of a new feature, a maintenance schedule associated with a client application, a release cycle associated with the client application, and the like. In some examples, the AI assistant management system may automatically compare newly received code source data with one or more previous versions of the source code in order to determine whether any changes have occurred.

In some examples, the AI assistant component may receive an indication that the source code and/or API documentation has been altered due to the addition of a new feature associated with the client application. To provide several non-limiting examples, a new software feature may include an option to change the resolution of the UI, a new notification or alert system, new view modes, search options, new voice recognition or voice command system, features related to new products and/or services, etc. The AI assistant management system employs continuous learning techniques to dynamically adapt to changes to the source code. New functionalities introduced in each release of a client application can be promptly captured and made available to the customized AI assistant, enabling the AI assistant to stay up to date with the latest software developments without manual intervention.

In some examples, the AI assistant management system may receive an indication that a new class or module has been introduced into the source code, that an existing class within the source code has been altered, that new logic has been added to existing functions, that a new configuration setting has been added (e.g., environment variables or entries in configuration files), that a new library or dependency has been included to support new features or improve existing ones, that an API has been modified (e.g., new endpoints are added or existing ones are changed), and the like. In some examples, the AI assistant management system may receive an indication that functions, classes, and/or modules of the source code that are not being used or needed (e.g., dead code) have been removed from the source code. In some examples, the AI assistant management system may receive an indication that the source code has been refactored and/or redundant logic has been removed, that similar code blocks have been consolidated, etc. In some examples, the AI assistant management system may receive an indication that an outdated feature represented in the source code has been replaced or otherwise become outdated or no longer supported. In some examples, the AI assistant management system may receive an indication that the source code has been altered in order to fix errors, bugs, or issues associated with the source code. In some examples, the AI assistant management system may receive an indication that the source code has been modified in order to improve performance, readability, etc. and the logic within functions or business rules have been modified. In some examples, the AI assistant management system may determine that the source code has been reordered or otherwise reorganized to improve readability or meet coding standards. In some examples, the AI assistant management system may receive an indication that portions of the source code has been toggled off or disabled without otherwise being deleted within the source code (e.g., in the case where the feature is being updated or testing is being performed on the feature). In some examples, the AI assistant management system may receive an indication that code elements (e.g., variables, function, classes etc.) have been renamed and/or refactored to better reflect their purpose after the source code functionality has evolved. In some examples, the AI assistant management system may receive an indication that the source code has been altered to include new or different API endpoints, parameters, response formats, etc.

In some examples, where the source code has been altered, the process 400 may include, at block 412, retraining the machine learning model(s). For example, the AI assistant management system may generate a new training data based at least in part on analyzing changes made to the source code data as discussed above. In some examples, the AI assistant management system may generate new training data based in part on determining a threshold number of changes have been made to the source code. In some examples, a machine learning model may be retrained during low network demand periods in order to minimize disruptions to users of the client application.

In examples where the source code has not been altered, the process 400 may include, at block 414, continuing to utilize the previous iteration of the machine learning model(s) for generating subsequent results for users.

### Example Clauses

A. A system comprising: one or more processors; and one or more non-transitory computer-readable media that, when executed by the one or more processors, cause the one or more processors to perform operations comprising: sending, to a client computing device, a request to access a source code repository associated with a client application, the source code repository including source code data; receiving, from the client computing device, access to the source code repository; determining training data based at least in part on domain logic data associated with the source code data, the domain logic data representing a set of rules that define functionalities of the client application; training a large language model (LLM) based at least in part on the training data, resulting in a trained LLM; generating, based at least part on the trained LLM, an artificial intelligence (AI) assistant component configured to be integrated into a user interface associated with the client application; and sending the AI assistant component to the client computing device for integration into the client application.

B. The system of paragraph A, wherein the client computing device is a first client computing device, the operations further comprising: sending, to a second client device, a request to access a second source code repository associated with a second client application different than the client application, the second source code repository comprising second source code data; receiving, from the second client device, access to the second source code repository; generating second training data based at least in part on second domain logic data associated with the second source code data, the second domain logic data representing a second set of rules that define second existing functionalities of the second client application; generating a second LLM; training the second LLM based at least in part on the second training data; generating a second AI assistant component configured to be integrated in a second user interface associated with the second client application; and providing access to the second AI assistant component to the second client device for integration.

C. The system of paragraphs A or B, wherein determining the training data comprises: determining, based at least in part on analyzing the source code data, one or more of: (i) a first API endpoint configured to retrieve first data from a first resource associated with the client application; (ii) a second API endpoint configured to send second data to a second resource associated with the client application; (iii) a third API endpoint configured to modify third data associated with the client application; and (iv) a fourth API endpoint configured to generate fourth data associated with the client application.

D. The system of any of paragraphs A-C, wherein the set of rules comprise: a first set of rules defining a method of generating data associated with the client application; a second set of rules defining a method of storing data associated with the client application; and a third set of rules defining a method of modifying data associated with the client application.

E. The system of any of paragraphs A-D, the operations further comprising: generating a unique identifier corresponding to a target HyperText Markup Language (HTML) element; and assigning the unique identifier to the AI assistant component, the unique identifier enabling the system to enable and disable utilization of the AI assistant component.

F. The system of any of paragraphs A-E, the operations further comprising: receiving, from the AI assistant component associated with the client application, a user input representing a task to be performed; generating, based at least in part on the trained LLM, an executable plan comprising a set of instructions to be automatically performed; and sending the executable plan to the AI assistant component for execution.

G. The system of any of paragraphs A-F, the operations further comprising: receiving an indication that the source code data associated with the client application has been altered, resulting in altered source code; generating second training data based at least in part on analyzing the altered source code; and retraining the LLM based at least in part on the second training data.

H. The system of any of paragraphs A-G, the operations further comprising: determining that the source code repository does not include API documentation data; and generating, based at least in part on the source code data, the API documentation data.

I. The system of any of paragraphs A-H, the operations further comprising: receiving, from the client computing device, a confirmation indicating that the AI assistant component has been integrated into the user interface associated with the client application.

J. One or more non-transitory computer-readable media storing instructions executable by one or more processors, wherein the instructions, when executed, cause the one or more processors to perform operations comprising: sending, to a client computing device, a request to access a source code repository associated with a client application, the source code repository including source code data; receiving, from the client computing device, access to the source code repository; determining training data based at least in part on domain logic data associated with the source code data, the domain logic data representing a set of rules that define functionalities of the client application; training a large language model (LLM) based at least in part on the training data, resulting in a trained LLM; generating, based at least part on the trained LLM, an artificial intelligence (AI) assistant component configured to be integrated into a user interface associated with the client application; and sending the AI assistant component to the client computing device for integration into the client application.

K. The one or more non-transitory computer-readable media of paragraph J, the operations further comprising: sending, to a second client device, a request to access a second source code repository associated with a second client application different than the client application, the second source code repository comprising second source code data; receiving, from the second client device, access to the second source code repository; generating second training data based at least in part on second domain logic data associated with the second source code data, the second domain logic data representing a second set of rules that define second existing functionalities of the second client application; generating a second LLM; training the second LLM based at least in part on the second training data; generating a second AI assistant component configured to be integrated in a second user interface associated with the second client application; and providing access to the second AI assistant component to the second client device for integration.

L. The one or more non-transitory computer-readable media of paragraph J or K, wherein determining the training data comprises: determining, based at least in part on analyzing the source code data, one or more of: (i) a first API endpoint configured to retrieve first data from a first resource associated with the client application; (ii) a second API endpoint configured to send second data to a second resource associated with the client application; (iii) a third API endpoint configured to modify third data associated with the client application; and (iv) a fourth API endpoint configured to generate fourth data associated with the client application.

M. The one or more non-transitory computer-readable media any of paragraphs J-L, wherein the set of rules comprise: a first set of rules defining a method of generating data associated with the client application; a second set of rules defining a method of storing data associated with the client application; and a third set of rules defining a method of modifying data associated with the client application.

N. The one or more non-transitory computer-readable media of any of paragraphs J-M, the operations further comprising: generating a unique identifier corresponding to a target HyperText Markup Language (HTML) element; and assigning the unique identifier to the AI assistant component, the unique identifier enabling an AI management system to enable and disable utilization of the AI assistant component.

O. The one or more non-transitory computer-readable media of any of paragraphs J-N, the operations further comprising: receiving, from the AI assistant component associated with the client application, a user input representing a task to be performed; generating, based at least in part on the trained LLM, an executable plan comprising a set of instructions to be automatically performed; and sending the executable plan to the AI assistant component for execution.

P. The one or more non-transitory computer-readable media of any of paragraphs J-O, the operations further comprising: receiving an indication that the source code data associated with the client application has been altered, resulting in altered source code; generating second training data based at least in part on analyzing the altered source code; and retraining the LLM based at least in part on the second training data.

Q. A method comprising: sending, to a client computing device, a request to access a source code repository associated with a client application, the source code repository including source code data; receiving, from the client computing device, access to the source code repository; determining training data based at least in part on domain logic data associated with the source code data, the domain logic data representing a set of rules that define functionalities of the client application; training a large language model (LLM) based at least in part on the training data, resulting in a trained LLM; generating, based at least part on the trained LLM, an artificial intelligence (AI) assistant component configured to be integrated into a user interface associated with the client application; and sending the AI assistant component to the client computing device for integration into the client application.

R. The method of paragraph Q, further comprising: determining that the source code repository does not include API documentation data; and generating, based at least in part on the source code data, the API documentation data.

S. The method of paragraphs Q or R, further comprising: receiving, from the client computing device, a confirmation indicating that the AI assistant component has been integrated into the user interface associated with the client application.

T. The method of any of paragraphs Q-S, further comprising: generating a unique identifier corresponding to a target HyperText Markup Language (HTML) element; and assigning the unique identifier to the AI assistant component, the unique identifier enabling an AI management system to enable and disable utilization of the AI assistant component.

While the example clauses described above are described with respect to one particular implementation, it should be understood that, in the context of this document, the content of the example clauses can also be implemented via a method, device, system, a computer-readable medium, and/or another implementation. Additionally, any of example's A-T may be implemented alone or in combination with any other one or more of the examples A-T.

While one or more examples of the techniques described herein have been described, various alterations, additions, permutations and equivalents thereof are included within the scope of the techniques described herein. For example, articles such as “a,” “an,” or “the” should be construed as being one or more elements. Moreover, a set should be construed as 0, 1, or more elements, since a set may be an empty set (i.e., a set comprising zero elements), a singleton (i.e., a set comprising a single element), or a set comprising multiple elements (i.e., a set comprising two or more elements). Moreover, it should be appreciated that the term “subset” describes a proper subset. A proper subset of set is a portion of the set that is not equal to the set. For example, if elements A, B, and C belong to a first set, a subset including elements A and B is a proper subset of the first set. However, a subset including elements A, B, and C is not a proper subset of the first set.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types. Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

What is claimed is:

1. A system comprising:
one or more processors; and
one or more non-transitory computer-readable media that, when executed by the one or more processors, cause the one or more processors to perform operations comprising:
sending, to a client computing device, a request to access a source code repository associated with a client application, the source code repository including source code data;
receiving, from the client computing device, access to the source code repository;
determining training data based at least in part on domain logic data associated with the source code data, the domain logic data representing a set of rules that define functionalities of the client application;
training a large language model (LLM) based at least in part on the training data, resulting in a trained LLM;
generating, based at least part on the trained LLM, an artificial intelligence (AI) assistant component configured to be integrated into a user interface associated with the client application; and
sending the AI assistant component to the client computing device for integration into the client application.

2. The system of claim 1, wherein the client computing device is a first client computing device, the operations further comprising:
sending, to a second client device, a request to access a second source code repository associated with a second client application different than the client application, the second source code repository comprising second source code data;
receiving, from the second client device, access to the second source code repository;
generating second training data based at least in part on second domain logic data associated with the second source code data, the second domain logic data representing a second set of rules that define second existing functionalities of the second client application;
generating a second LLM;
training the second LLM based at least in part on the second training data;
generating a second AI assistant component configured to be integrated in a second user interface associated with the second client application; and
providing access to the second AI assistant component to the second client device for integration.

3. The system of claim 1, wherein determining the training data comprises:
determining, based at least in part on analyzing the source code data, one or more of:
(i) a first API endpoint configured to retrieve first data from a first resource associated with the client application;
(ii) a second API endpoint configured to send second data to a second resource associated with the client application;
(iii) a third API endpoint configured to modify third data associated with the client application; and
(iv) a fourth API endpoint configured to generate fourth data associated with the client application.

4. The system of claim 1, wherein the set of rules comprise:
a first set of rules defining a method of generating data associated with the client application;
a second set of rules defining a method of storing data associated with the client application; and
a third set of rules defining a method of modifying data associated with the client application.

5. The system of claim 1, the operations further comprising:
generating a unique identifier corresponding to a target HyperText Markup Language (HTML) element; and
assigning the unique identifier to the AI assistant component, the unique identifier enabling the system to enable and disable utilization of the AI assistant component.

6. The system of claim 1, the operations further comprising:
receiving, from the AI assistant component associated with the client application, a user input representing a task to be performed;
generating, based at least in part on the trained LLM, an executable plan comprising a set of instructions to be automatically performed; and
sending the executable plan to the AI assistant component for execution.

7. The system of claim 1, the operations further comprising:
receiving an indication that the source code data associated with the client application has been altered, resulting in altered source code;
generating second training data based at least in part on analyzing the altered source code; and
retraining the LLM based at least in part on the second training data.

8. The system of claim 1, the operations further comprising:
determining that the source code repository does not include API documentation data; and
generating, based at least in part on the source code data, the API documentation data.

9. The system of claim 1, the operations further comprising:
receiving, from the client computing device, a confirmation indicating that the AI assistant component has been integrated into the user interface associated with the client application.

10. One or more non-transitory computer-readable media storing instructions executable by one or more processors, wherein the instructions, when executed, cause the one or more processors to perform operations comprising:
sending, to a client computing device, a request to access a source code repository associated with a client application, the source code repository including source code data;
receiving, from the client computing device, access to the source code repository;
determining training data based at least in part on domain logic data associated with the source code data, the domain logic data representing a set of rules that define functionalities of the client application;
training a large language model (LLM) based at least in part on the training data, resulting in a trained LLM;
generating, based at least part on the trained LLM, an artificial intelligence (AI) assistant component configured to be integrated into a user interface associated with the client application; and
sending the AI assistant component to the client computing device for integration into the client application.

11. The one or more non-transitory computer-readable media of claim 10, the operations further comprising:
sending, to a second client device, a request to access a second source code repository associated with a second client application different than the client application, the second source code repository comprising second source code data;
receiving, from the second client device, access to the second source code repository;
generating second training data based at least in part on second domain logic data associated with the second source code data, the second domain logic data representing a second set of rules that define second existing functionalities of the second client application;
generating a second LLM;
training the second LLM based at least in part on the second training data;
generating a second AI assistant component configured to be integrated in a second user interface associated with the second client application; and
providing access to the second AI assistant component to the second client device for integration.

12. The one or more non-transitory computer-readable media of claim 10, wherein determining the training data comprises:
determining, based at least in part on analyzing the source code data, one or more of:
(i) a first API endpoint configured to retrieve first data from a first resource associated with the client application;
(ii) a second API endpoint configured to send second data to a second resource associated with the client application;
(iii) a third API endpoint configured to modify third data associated with the client application; and
(iv) a fourth API endpoint configured to generate fourth data associated with the client application.

13. The one or more non-transitory computer-readable media of claim 10, wherein the set of rules comprise:
a first set of rules defining a method of generating data associated with the client application;
a second set of rules defining a method of storing data associated with the client application; and
a third set of rules defining a method of modifying data associated with the client application.

14. The one or more non-transitory computer-readable media of claim 10, the operations further comprising:
generating a unique identifier corresponding to a target HyperText Markup Language (HTML) element; and
assigning the unique identifier to the AI assistant component, the unique identifier enabling an AI management system to enable and disable utilization of the AI assistant component.

15. The one or more non-transitory computer-readable media of claim 10, the operations further comprising:
receiving, from the AI assistant component associated with the client application, a user input representing a task to be performed;
generating, based at least in part on the trained LLM, an executable plan comprising a set of instructions to be automatically performed; and
sending the executable plan to the AI assistant component for execution.

16. The one or more non-transitory computer-readable media of claim 10, the operations further comprising:
receiving an indication that the source code data associated with the client application has been altered, resulting in altered source code;
generating second training data based at least in part on analyzing the altered source code; and
retraining the LLM based at least in part on the second training data.

17. A method comprising:
sending, to a client computing device, a request to access a source code repository associated with a client application, the source code repository including source code data;
receiving, from the client computing device, access to the source code repository;
determining training data based at least in part on domain logic data associated with the source code data, the domain logic data representing a set of rules that define functionalities of the client application;
training a large language model (LLM) based at least in part on the training data, resulting in a trained LLM;
generating, based at least part on the trained LLM, an artificial intelligence (AI) assistant component configured to be integrated into a user interface associated with the client application; and
sending the AI assistant component to the client computing device for integration into the client application.

18. The method of claim 17, further comprising:
determining that the source code repository does not include API documentation data; and
generating, based at least in part on the source code data, the API documentation data.

19. The method of claim 17, further comprising:
receiving, from the client computing device, a confirmation indicating that the AI assistant component has been integrated into the user interface associated with the client application.

20. The method of claim 17, further comprising:
generating a unique identifier corresponding to a target HyperText Markup Language (HTML) element; and
assigning the unique identifier to the AI assistant component, the unique identifier enabling an AI management system to enable and disable utilization of the AI assistant component.
